(19) United States
(12) Patent Application Publication
(10) Pub. No.: US 2007/0036400 A1
(43) Pub. Date: Feb. 15, 2007

(54) User authentication using biometric information

(75) Inventors: Keisuke Watanabe, Mizuho-City (JP); Hirofumi Saitoh, Ogaki-City (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 11/390,249

(22) Filed: Mar. 28, 2006

(30) Foreign Application Priority Data
Mar. 29, 2005 (JP) 2005-096418
Mar. 28, 2005 (JP) 2005-093208
Mar. 29, 2005 (JP) 2005-096317

(51) Int. Cl. G06K 9/00

(52) U.S. Cl. 382/124

(57) ABSTRACT

An input unit accepts a fingerprint image of a user. A pre-extraction and categorization unit generates pre-extracted data from the fingerprint image and uses the data to categorize the input fingerprint image into one of multiple groups. A feature extraction unit extracts fingerprint feature data from the fingerprint image by processing methods defined for the respective groups. A feature data matching processing unit matches the fingerprint feature data against fingerprint authentication data registered in a fingerprint authentication database by processing methods defined for the respective groups. An integrated authentication unit authenticates a user with the input fingerprint image based upon a result of matching.

### BACKGROUND OF THE INVENTION

1. Field of the Invention

The present invention relates to a registration (enrollment) technology and an authentication technology and, more particularly, to a registration technology and an authentication technology for authenticating a user using biometric information.

2. Description of the Related Art

In biometric authentication using biometric information such as fingerprints, palm prints, faces, iris, voice prints or the like as a target of authentication, parameters, for use in feature extraction performed in registering (enrolling) biometric information or in authenticating biometric information, are tuned to adapt to typical biometric information. The parameters thus tuned are fixed throughout their use. For example, threshold values and constants for image resolution in image processing or various parameters in fingerprint feature extraction are optimized to adapt to typical fingerprints (for example, fingerprints of adults). In fingerprint authentication, parameters thus optimized are used for image processing and feature extraction in registering and authenticating fingerprints so as to guarantee certain authentication precision.

If feature extraction is performed using different parameters and under different conditions in registration and in authentication, False Reject Rate (FRR), i.e., the probability that a legitimate user is not authenticated is increased, given that an authentication threshold remains unchanged. In order to lower False Reject Rate (FRR), the authentication threshold may be lowered. In that case, False Accept Rate (FAR), i.e., the probability of an illegitimate user being recognized as a legitimate user, will be increased.

A technology is known which is directed to improving recognition rate in face recognition, wherein face images are registered in image databases adapted to respective attributes corresponding to different situations in which face recognition is performed. An image database of an attribute most suitable for the situation in which face recognition is performed is selected for personal identification based upon the face image (JP 2004-127285 A). According to this approach, images to be referred to are reduced in number so that recognition rate is expected to be improved.

One of problems with a fingerprint authentication system is that, since image resolution in image processing and feature point extraction filters are tuned to adapt to typical users, people with fingerprints quite different from typical patterns (for example, people with small fingers and small wrinkles or people with rough skin) often fail to be authenticated. Authentication systems that are currently in use are run by providing an alternative means such as password authentication to users for which fingerprint authentication is unavailable. Such measures run counter to the spirit of introducing biometric authentication to enhance security. Individual differences between subjects of authentication that require modifications to processing parameters will be encountered not only in fingerprint authentication but also in iris authentication and face authentication. It is unavoidable that there are users who do not fit the authentication system built upon typical biometric information, causing operability problem in the authentication system.

### SUMMARY OF THE INVENTION

A primary purpose of the present invention in this background is to provide an authentication technology applicable to users who are not suitably dealt with in ordinary authentication systems due to their unique physical features.

In one embodiment of the present invention, a registration apparatus comprises: an input unit which receives biometric information of a subject of registration; a pre-extraction unit which extracts first feature data from biometric information by a predetermined feature extraction method; a categorization unit which determines categorization data for use in categorizing the biometric information into a plurality of groups, by using the first feature data; a feature extraction unit which extracts second feature data from the biometric information by using feature extraction methods adapted for the respective groups; and a registration unit which relates the first feature data, the second feature data and the categorization data to each other and stores them as reference biometric information.

According to this embodiment, the first feature data and the second feature data extracted from input biometric information are related to each other and stored as reference biometric information. Therefore, authentication precision is improved. By using the categorization data as indexes, the registration unit can efficiently retrieve the reference biometric information.

The categorization unit may define the categorization data as denoting an area in which the second feature data is extracted from the input biometric information. With this, a feature extraction method adapted for the characteristics of an area in which the second feature data is extracted may be used.

The input biometric information may be fingerprint information, and the pre-extraction unit may comprise a ridge direction extraction unit for extracting from the fingerprint information a ridge direction in a fingerprint and output data obtained by subjecting ridge direction to a statistical process, as the first feature data. With this, biometric authentication using the first feature data can be performed.

An authentication apparatus according to another embodiment comprises: an input unit which receives biometric information of a subject of registration; a pre-extraction unit which extracts first feature data from biometric information by a predetermined feature extraction method; a categorization unit which determines categorization data for use in categorizing the biometric information into a plurality of groups by using the first feature data; a feature extraction unit which extracts second feature data from the biometric information by using feature extraction methods adapted for the respective groups; a matching processing unit which stores reference biometric information to be referred to in authentication, indexing the reference biometric information using the categorization data, and which matches the second feature data against the reference biometric information by matching methods adapted for the respective groups; and an authentication unit which authenticates the biometric information based upon a result of matching.

According to this embodiment, the second feature data is matched against the reference biometric information by the matching methods adapted for the respective groups defined according to the categorization data. Therefore, matching precision is improved.

The authentication apparatus may further comprise a pre-extracted data matching unit which matches the first feature data against the first feature data included in the reference biometric information, wherein the authentication unit refers both to a result of matching in the matching processing unit and to a result of matching in the pre-extracted data matching unit so as to determine whether to authenticate the input biometric information. Since authentication is performed using both the result of matching that uses the first feature data and the result of matching that uses the second feature data, the frequency of matching failure is reduced.

The authentication unit may make a determination based upon a result obtained by weighting the result of matching in the matching processing unit and the result of matching in the pre-extracted data matching unit, the weighting being done using the categorization data. By weighting the results by the categorization data, authentication that allows for the characteristics of the feature extraction processes for respectively extracting the first feature data and the second feature data is achieved.

In another embodiment of the present invention, a registration method comprises: determining categorization data for use in categorizing input biometric information into a plurality of groups, in accordance with first feature data extracted from the biometric information; extracting second feature data from the biometric information by feature extraction methods adapted for the plurality of groups; and relating the first feature data, the second feature data and the categorization data to each other and registering them as reference biometric information.

In still another embodiment of the present invention, an authentication method comprises: categorizing input biometric information into a plurality of categories in accordance with first feature data extracted from the biometric information; extracting second feature data from the biometric information by feature extraction methods adapted for the respective groups; matching pre-registered reference biometric information against the second feature data by matching methods adapted for the respective groups; and authenticating the biometric information based upon a result of matching.

Optional combinations of the aforementioned constituting elements, and implementations of the invention in the form of methods, apparatuses, systems, recording mediums and computer programs may also be practiced as additional modes of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows the structure of a fingerprint registration apparatus according to a first example of practicing a first embodiment of the present invention;

FIG. 2 shows the structure of a pre-extraction and categorization unit of FIG. 1;

FIG. 3 shows an example of how pre-extracted data and feature data are obtained;

FIG. 4 shows the structure of a fingerprint authentication apparatus according to another example of practicing the first embodiment;

FIGS. 5A and 5B show messages displayed on an authentication result display unit of FIG. 4;

FIG. 6 shows the structure of an authentication system according to another example of practicing the first embodiment;

FIG. 7 is a flowchart showing a procedure of registering a fingerprint in the fingerprint registration apparatus of FIG. 1;

FIG. 8 is a flowchart showing a procedure of authenticating a fingerprint in the fingerprint authentication apparatus of FIG. 4;

FIG. 9 shows a process applied to a fingerprint image according to a first example of practicing a second embodiment of the present invention;

FIG. 10 is a functional block diagram of a matching apparatus according to the first example of practicing the second embodiment;

FIG. 11 is a flowchart showing a process for generating reference data for use in the matching apparatus according to the first example of practicing the second embodiment;

FIG. 12 shows the data structure of a feature point feature table stored according to the first example of practicing the second embodiment;

FIG. 13 shows the data structure of a ridge feature index table stored according to the first example of practicing the second embodiment;

FIG. 14 is a flowchart for an authentication process in a matching apparatus according to the first example of practicing the second embodiment;

FIG. 15 is a graph showing how pattern matching according to the first example of practicing the second embodiment is applied to direction vector distribution in a reference image and an image to be authenticated;

FIG. 16 shows the data structure of a ridge feature index table stored according to a second example of practicing the second embodiment;

FIG. 17 is a functional block diagram of a matching apparatus according to a first example of practicing a third embodiment of the present invention;

FIG. 18 is a flowchart showing a process for generating reference data for use in the matching apparatus according to the first example of practicing the third embodiment;

FIG. 19 shows a fingerprint image built according to the first example of practicing the third embodiment;

FIG. 20 shows an example of how average values of direction vectors calculated according to the first example of practicing the third embodiment are distributed;

FIG. 21 is a flowchart showing an authentication process in the matching apparatus according to the first example of practicing the third embodiment;

FIG. 22 is a graph showing how pattern matching according to the first example of practicing the third embodiment is applied to direction vector average value distribution in a reference image and an image to be authenticated;

FIGS. 23A and 23B show how the distribution of average values of direction vectors is corrected by the distribution of the number of ridges according to the first example of practicing the third embodiment;

FIG. 24 is a flowchart showing a process for generating reference data for use in a matching apparatus according to a second example of practicing the third embodiment;

FIG. 25 shows a ridge angle obtained according to the second example of practicing the third embodiment;

FIG. 26 schematically shows how a reference fingerprint image, a first category distribution and a second category distribution correspond to each other according to the second example of practicing the third embodiment;

FIG. 27 is a flowchart for an authentication process in the matching apparatus according to the second example of practicing the third embodiment;

FIG. 28 is a flowchart for a process of producing reference data for use in the matching apparatus according to a third example of practicing the third embodiment; and

FIG. 29 shows a ridge area length obtained according to the third example of practicing the third embodiment.

### DETAILED DESCRIPTION OF THE INVENTION

The invention will now be described by reference to the preferred embodiments. This does not intend to limit the scope of the present invention, but to exemplify the invention.

### Embodiment 1

A summary will be given before giving a specific description of a first embodiment of the present invention. The first embodiment relates to a fingerprint registration apparatus for registering users' fingerprints. The fingerprint registration apparatus receives fingerprint images of users and extracts features from the fingerprint images. Feature data extracted in this process will be referred to as “pre-extracted data”. The fingerprint registration apparatus determines category data for use in categorizing the fingerprint images into two groups, based upon the pre-extracted data. Image processing methods corresponding to the respective groups are predefined. An input fingerprint image is subject to image processing corresponding to the group to which the image belongs for further feature extraction. The feature extracted in this process will be referred to as “fingerprint feature data”. A set of fingerprint feature data, categorization data and pre-extracted data are registered as fingerprint authentication data to be referred to in later authentication.

Another example of practicing the first embodiment relates to a fingerprint authentication apparatus for authenticating the fingerprint of a user. The fingerprint authentication apparatus receives a fingerprint image of a user, extracts pre-extracted data as does the fingerprint registration apparatus, and categorizes fingerprint images into two groups. The fingerprint image is then subject to image processing corresponding to the group so as to extract fingerprint feature data. The fingerprint feature data is matched against the pre-registered fingerprint authentication data for authentication of the user.

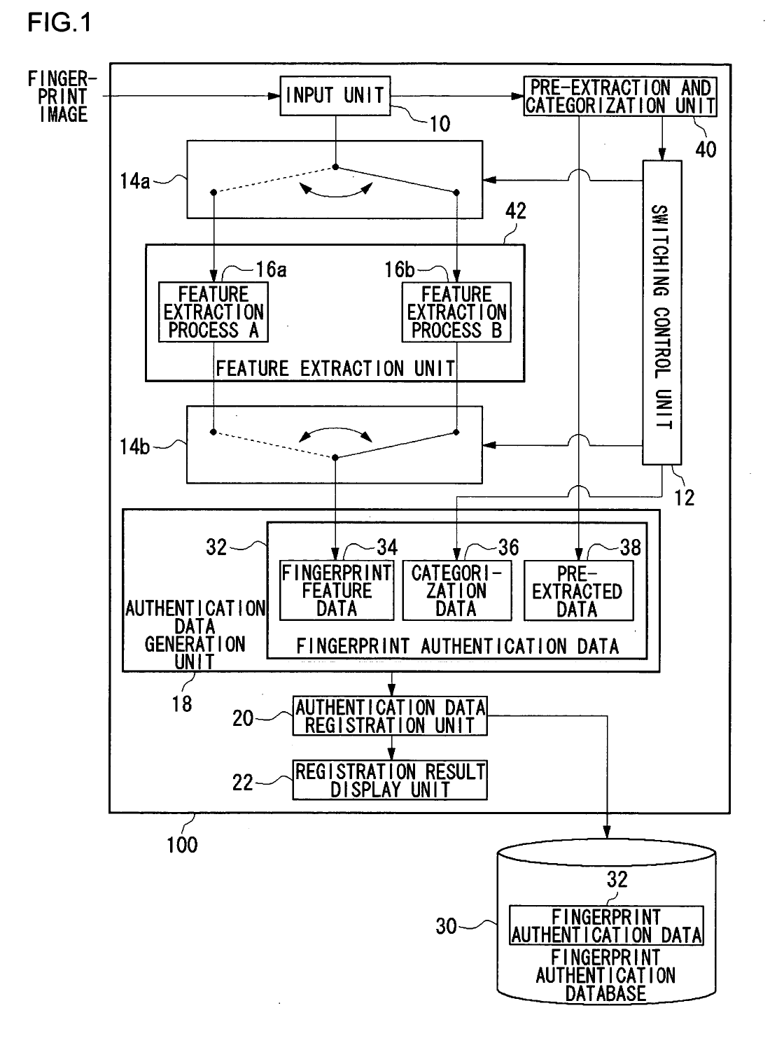

FIG. 1 shows the structure of a fingerprint registration apparatus 100 according to the first example of practicing the first embodiment. The fingerprint registration apparatus 100 includes an input unit 10, a pre-extraction and categorization unit 40, a switching control unit 12, a switch 14a, a switch 14b, a feature extraction unit 42, an authentication data generation unit 18, an authentication data registration unit 20 and a registration result display unit 22. The feature extraction unit 42 includes a first feature extraction processing unit 16a and a second feature extraction processing unit 16b which use different algorithms for feature extraction.

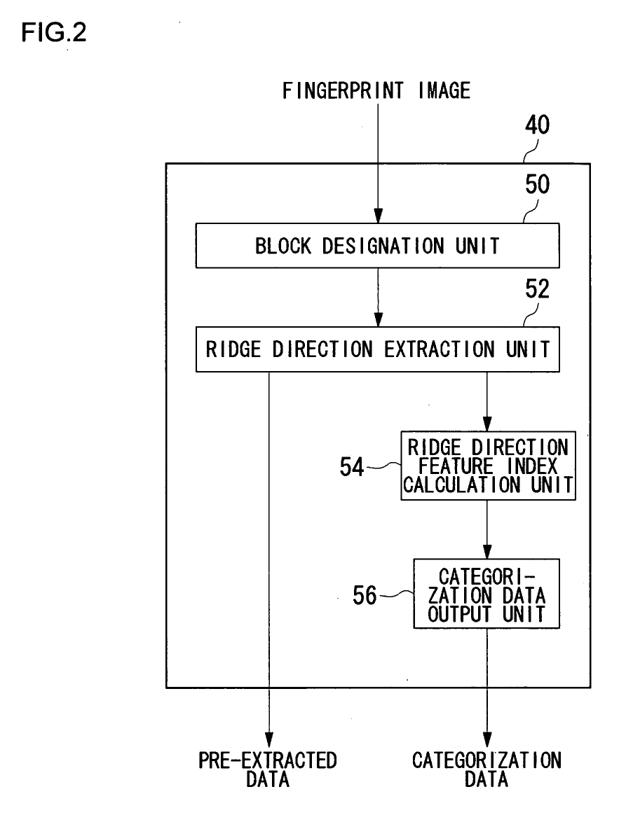

The input unit 10 accepts information on the fingerprint of a user as biometric information to be registered. The information on fingerprint may be a fingerprint image digitized by a scanner. The pre-extraction and categorization unit 40 extracts features from a fingerprint image. The features extracted in this process are referred to as pre-extracted data 38. The pre-extraction and categorization unit 40 uses the pre-extracted data 38 to output categorization data for use in categorizing an input fingerprint image into one of multiple groups defined in accordance with individual differences. In this embodiment, the pre-extraction and categorization unit 40 outputs, as categorization data, the size of a sub-area of the fingerprint image input to the input unit 10 from which area the feature extraction unit 42 extracts features. The categorization data specifies the width of an image area by designating, for example, “30 lines” or “10 lines”. Alternatively, the categorization data may specify an interval between ridges in the fingerprint or the size of the fingerprint image as a whole. Details of the process in the pre-extraction and categorization unit 40 will be described later with reference to FIG. 2.

The switching control unit 12 controls the switches 14a and 14b in accordance with the categorization data received from the pre-extraction and categorization unit 40 and selects one of the first feature extraction processing unit 16a and the second feature extraction processing unit 16b provided in the feature extraction unit 42. When the categorization data designates “30 lines”, the switching control unit 12 switches to the first feature extraction processing unit 16a performing a feature extraction process A suitable for feature extraction from a relatively wide image area. When the categorization data designates “10 lines”, the switching control unit 12 switches to the second feature extraction processing unit 16b performing a feature extraction process B suitable for feature extraction from a relatively small image area.

The first feature extraction processing unit 16a and the second feature extraction processing unit 16b extract data on features of fingerprints such as feature points, using a feature extraction method specified for each group defined by the categorization data. The feature extraction methods of the first feature extraction processing unit 16a and the second feature extraction processing units may differ in algorithms themselves for extracting data on features of fingerprints. Alternatively, parameters for extraction may differ, while the algorithms are identical. It is preferable that the feature extraction methods employed in the feature extraction processing units differ from that of the pre-extraction and categorization unit 40 for obtaining pre-extracted data.

The authentication data generation unit 18 generates fingerprint authentication data 32 of a predetermined format including the fingerprint feature data extracted by the feature extraction unit 42, the categorization data provided by the switching control unit 12, and the pre-extracted data 38 provided by the pre-extraction and categorization unit 40. The authentication data registration unit 20 registers the fingerprint authentication data 32 in a fingerprint authentication database 30, organizing the data into groups defined by the categorization data. The fingerprint authentication data 32 corresponding to group A is stored in an area of the fingerprint authentication database 30 corresponding to group A defined by the categorization data designating “30 lines”. The fingerprint authentication data 32 corresponding to group B is stored in an area of the fingerprint authentication database 30 corresponding to group B defined by the categorization data designating “10 lines”. By taking advantage of the categorization data as index information for indexing the fingerprint authentication data 32 in the fingerprint authentication database 30, the fingerprint authentication data 32 can be retrieved easily in a search. The areas for storing the fingerprint authentication data 32 corresponding to groups A and B as defined by the categorization data may be physically separated or logically separated.

In an alternative embodiment, the categorization data 36 may not be included in the fingerprint authentication data 32. In this case, the authentication data generation unit 18 generates the fingerprint authentication data 32 by associating the fingerprint feature data 34 with the pre-extracted data 38. The authentication data registration unit 20 refers to the categorization data 36 and stores the fingerprint authentication data 32 in respective areas in the fingerprint authentication database 30, organizing the data into groups defined by categorization data.

Thus, the fingerprint authentication database 30 categorizes the fingerprint authentication data into two groups in accordance with the categorization data. Therefore, the number of targets to be searched for a match in authenticating a fingerprint is reduced to half so that the search speed is improved accordingly. By limiting the number of targets to be searched for a match, authentication precision is improved.

The registration result display unit 22 displays a message on a display or the like indicating to a user that fingerprint registration is complete. If the features of a fingerprint cannot properly be extracted due to, for example, an unclear fingerprint image and so cannot be registered, the registration result display unit 22 displays a message prompting the user to input a fingerprint image for a second time. The registration result display unit 22 may present the categorization data output from the pre-extraction and categorization unit 40 to the user. In addition to displaying a message or the categorization data on a display, the registration result display unit 22 may notify a personal computer or the like of the displayed contents over a network (not shown).

The structure as described above may be implemented by hardware including a CPU, a memory and an LSI of any computer and by software including a program loaded into the memory. FIG. 1 depicts functional blocks implemented by cooperation of the hardware and software. Therefore, it will be obvious to those skilled in the art that the functional blocks may be implemented by a variety of manners including hardware only, software only or a combination of both.

FIG. 2 shows the detailed structure of the pre-extraction and categorization unit 40. The pre-extraction and categorization unit 40 includes a block designation unit 50, a ridge direction extraction unit 52, a ridge direction feature index calculation unit 54 and a categorization data output unit 56. The block designation unit 50 extracts a block in an input fingerprint image where a fingerprint is located. For example, the central portion of a fingerprint image is extracted. For extraction of the central portion of a fingerprint image, the block designation unit 50 divides the fingerprint image into areas of small sizes and calculates the average values of the pixels included in the areas. The area determined to include the largest pixel values as a result of comparison between averaged pixel values is designated as the center of the fingerprint image. An area of a predetermined size around an area designated as the center of the fingerprint image is designated as a block.

The ridge direction extraction unit 52 derives the directions of ridges in a fingerprint in a block designated by the block designation unit 50. The direction of a ridge may be a direction tangential to the ridge. Ridge direction data thus extracted is subject to a predetermined statistical process before being output to the authentication data generation unit 18 as pre-extracted data.

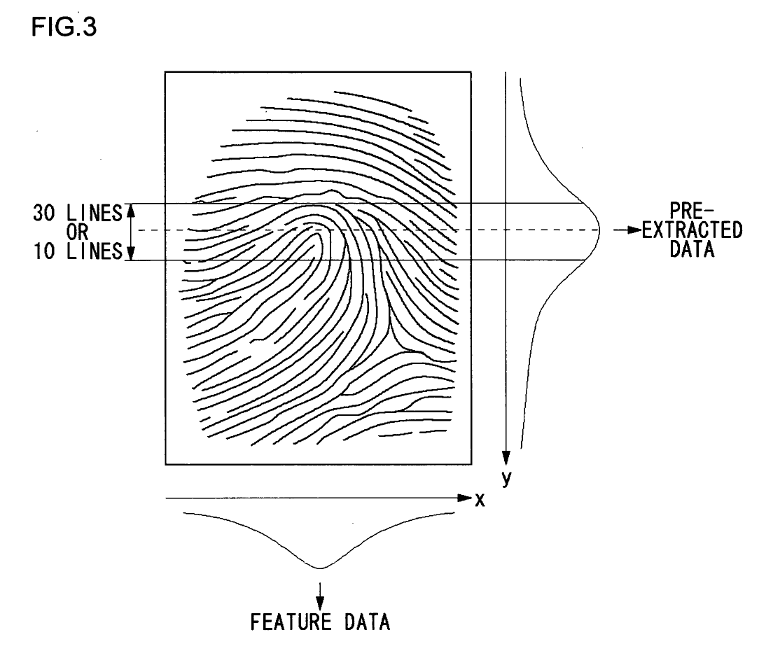

FIG. 3 shows an example of pre-extracted data. Vectors that characterize the direction of ridges in a line block that extends in the horizontal direction in a fingerprint image are determined and the components of the vectors are calculated. A score is derived in accordance with the distribution of the components. By adding up the scores for all ridges in the block, a feature index for the line block is obtained. A histogram obtained as a result of performing the above process on the entirety of the fingerprint image constitutes pre-extracted data.

The ridge direction feature index calculation unit 54 derives a characteristic portion by referring to the directions of ridges extracted by the ridge direction extraction unit 52. For example, a peak position in the histogram of pre-extracted data may be defined as a characteristic portion. The categorization data output unit 56 determines the categorization data for switching between different feature extraction processes in the feature extraction unit 42, based upon the characteristic portion thus extracted. The categorization data is defined as the size of a window to be used in extracting feature data from a fingerprint image. For example, it is specified that 30 lines on both sides of the peak position of a histogram of pre-extracted data shall be subject to processing by the feature extraction unit 42 or that 10 lines on both sides of the peak position shall be subject to processing. The categorization data designates “30 lines” or “10 lines”. Whether the categorization data should designate 30 lines or 10 lines may be determined based upon ridge direction, ridge count or ridge interval of a fingerprint image. Determination may be made depending on whether the peak value of a histogram of pre-extracted data is larger than a predetermined threshold value. If the peak value of the histogram is large, it is considered that a sufficiently large number of features for the purpose of matching are found in the vicinity of the peak value. In that case, the categorization data may designate “10 lines”, establishing a relatively narrow area for feature extraction by the feature extraction unit 42. If the peak value is relatively small, it is considered that not many features are found in the vicinity of the peak value. In this case, the categorization data may designate “30 lines” to establish an extensive area for feature extraction by the feature extraction unit 42. The categorization data may provide other definitions. For example, the categorization data may designate “upper half area” or “lower half area”, depending on whether the peak position of a histogram of pre-extracted data is located in the upper half or the lower half of a fingerprint image. Alternatively, the categorization data may designate “a portion of a fingerprint image” or “the whole of a fingerprint image”, depending on whether or not the width of a valid input fingerprint image is below a predetermined value.

The fingerprint image input received by the input unit 10 is categorized into group A or group B in accordance with the categorization data. In the above example, group A corresponds to the categorization data designating “30 lines” and group B corresponds to the categorization data designating “10 lines”.

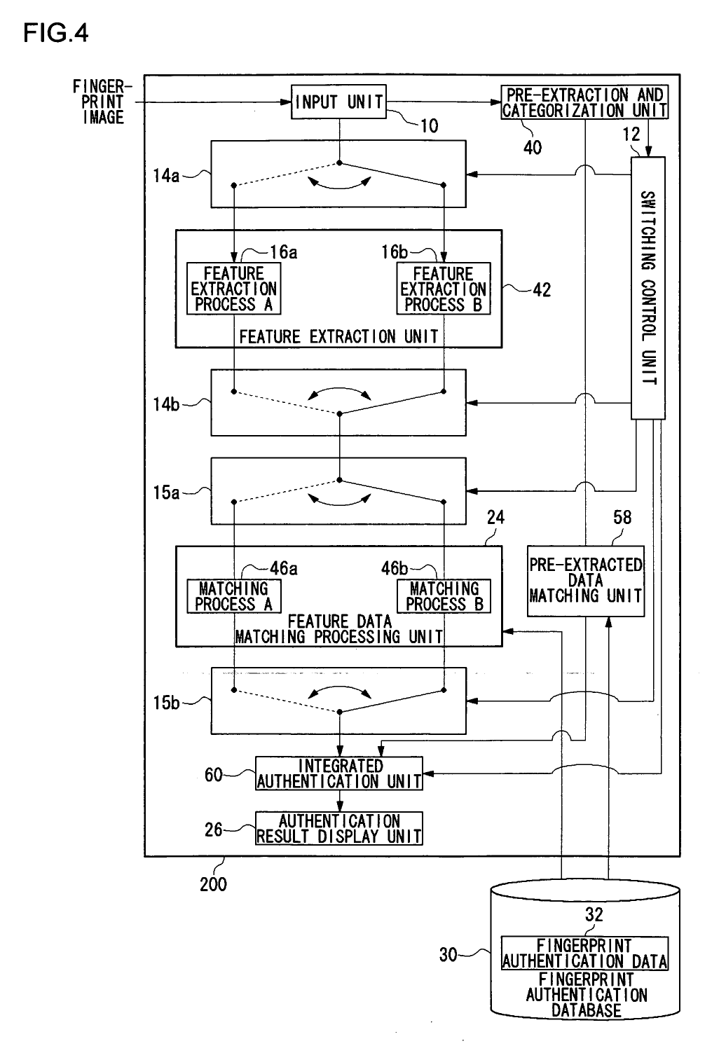

FIG. 4 shows the structure of a fingerprint authentication apparatus 200 according to another example of practicing the first embodiment. The fingerprint authentication apparatus 200 includes an input unit 10, a pre-extraction and categorization unit 40, a switching control unit 12, a switch 14a, a switch 14b, a switch 15a, a switch 15b, a feature extraction unit 42, a feature data matching processing unit 24, a pre-extracted data matching unit 58, an integrated authentication unit 60 and an authentication result display unit 26. The feature extraction unit 42 includes a first feature extraction processing unit 16a and a second feature extraction processing unit 16b. The feature data matching processing unit 24 includes a first matching processing unit 46a and a second matching processing unit 46b.

The functional blocks may be implemented by a variety of manners including hardware only, software only or a combination of both. The fingerprint authentication apparatus 200 receives a fingerprint image from a user and authenticated the user accordingly. The structures of the components of the fingerprint authentication apparatus 200 including the input unit 10, the pre-extraction and categorization unit 40, the switching control unit 12, the switches 14a and 14b, and the feature extraction unit 42 are the same as the structures of the corresponding components of the fingerprint registration apparatus 100 of FIG. 1 so that the description thereof is omitted.

The switching control unit 12 controls the switches 15a and 15b in accordance with the grouping determined according to the categorization data received from the pre-extraction and categorization unit 40 and selects one of the first matching processing unit 46a and the second matching processing unit 46b provided in the feature data matching processing unit 24. When the categorization data designates “30 lines”, the switching control unit 12 switches to the first matching processing unit 46a performing a matching process A suitable for matching of feature data extracted from a relatively large image area. When the categorization data designates “10 lines”, the switching control unit 12 switches to the second matching processing unit 46a performing a matching process A suitable for matching of feature data extracted from a relatively small image area.

The first matching processing unit 46a and the second matching processing unit 46 match the fingerprint feature data output from the feature extraction unit 42 against the fingerprint authentication data 32 registered in the fingerprint authentication database 30 so as to calculate similarity between the data. If the fingerprint feature data belongs to group A, the first matching processing unit 46a matches the data against the fingerprint authentication data 32 registered in association with group A. If the fingerprint feature data belongs to group B, the second matching processing unit 46b matches the data against the fingerprint authentication data 32 registered in association with group B.

For example, matching is performed by using a pattern matching approach between the fingerprint feature data to be authenticated and the fingerprint authentication data. Pattern matching may be performed by detecting a difference between the fingerprint feature data to be authenticated and the fingerprint authentication data. Similarity is calculated by turning the difference into a score by a known method.

The pre-extracted data matching unit 58 matches the pre-extracted data obtained in the pre-extraction and categorization unit 40 against the fingerprint authentication data 32 registered in the fingerprint authentication database so as to calculate similarity between the data. In this process, the same method as used in the feature data matching processing unit 24 may be used.

The integrated authentication unit 60 refers to the similarity calculated by the feature data matching processing unit 24 and the similarity calculated by the pre-extracted data matching unit 58 for authentication of the user with the input fingerprint image. For calculation of authentication scores, it is preferable that the integrated authentication unit 60 weight the similarity by referring to the categorization data output from the switching control unit 12.

For example, weighting is performed as described below. It will be assumed that the categorization data designates either “30 lines” or “10 lines”. If the feature extraction in the feature extraction unit 42 corresponds to the categorization data designating “30 lines”, the integrated authentication unit 60 assigns a lower weight to the similarity calculated in the feature data matching processing unit 24 than to the similarity calculated by the pre-extracted data matching unit 58. If the feature extraction in the feature extraction unit 42 corresponds to the categorization data designating “10 lines”, the integrated authentication unit 60 assigns an equal weight to the similarity calculated in the feature data matching processing unit 24 and to the similarity calculated by the pre-extracted data matching unit 58.

Weighting is done for the following reasons. In a situation where an area subject to feature extraction by the feature extraction unit 42 is set up at the upper end or the lower end of a fingerprint image, and if the area thus set up includes 30 lines, the area may protrude out of the fingerprint image, prohibiting features from being properly extracted. In this case, false acceptance may occur if the integrated authentication unit 60 allows the similarity from the featured at a matching processing unit 24 to make a large contribution to the score. It is for this reason that the weight assigned to the similarity calculated by the feature data matching processing unit 24 is lowered if the feature extraction in the feature extraction unit 42 corresponds to the categorization data designating “30 lines”.

Conversely, when it is expected that the precision of feature extraction by the pre-extraction and categorization unit 40 is low, the weight assigned to the similarity calculated by the feature data matching processing unit 24 may be set higher than the weight assigned to the similarity calculated by the pre-extracted data matching unit 58.

Weighting of similarity by the integrated authentication unit 60 may not necessarily be in accordance with the approach described above. Weighting that optimizes authentication precision may be determined in accordance with algorithms in the pre-extraction and categorization unit 40 and the feature extraction unit 42.

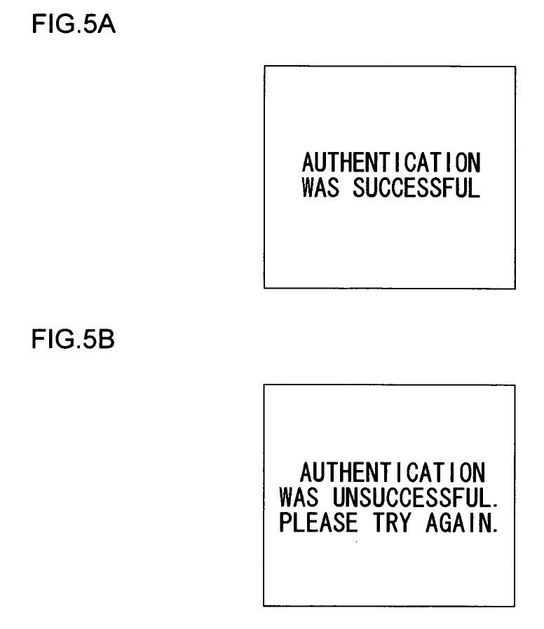

The integrated authentication unit 60 performs fingerprint authentication by referring to the authentication score calculated as described above. If the integrated authentication unit 60 determines that the fingerprint is of a registered user, the authentication result display unit 26 displays a message indicating that authentication is successful to a user. When the fingerprint does not match that of any registered user, the authentication result display unit 26 displays a message indicating that authentication fails. FIGS. 5A and 5B show messages displayed on the authentication result display unit 26. FIG. 5A shows a message displayed when authentication is successful. FIG. 5B shows a message displayed when authentication fails. In addition to displaying such messages on a display, the authentication result display unit 26 may deliver such a message to a personal computer or the like via a network (not shown).

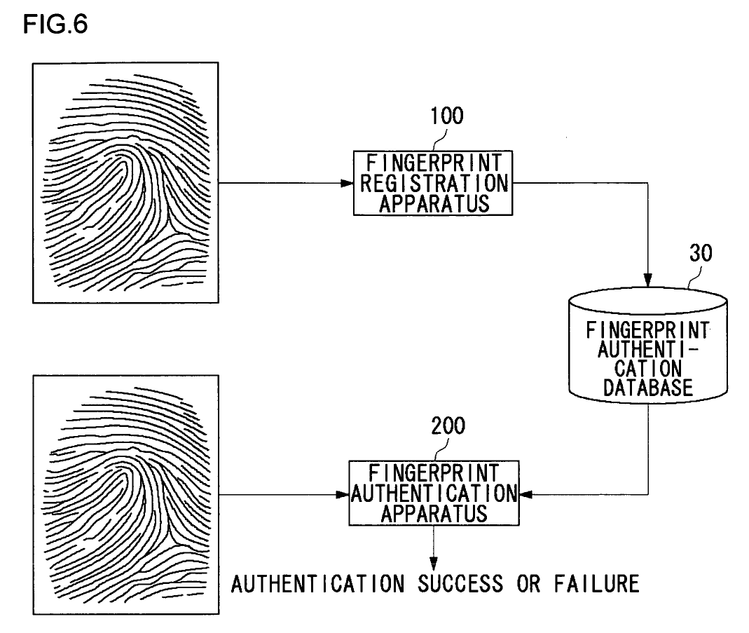

FIG. 6 shows the structure of the authentication system according to another example of practicing the first embodiment. The authentication system comprises the fingerprint registration apparatus 100 of FIG. 1 and the fingerprint authentication apparatus 200 of FIG. 4 sharing access to the fingerprint authentication database 30.

When a user inputs a fingerprint image to the fingerprint registration apparatus 100 for registration, the fingerprint registration apparatus 100 generates pre-extracted data and feature data from the input fingerprint image. The fingerprint registration apparatus 100 then generates the fingerprint authentication data 32 including the pre-extracted data and the feature data and registers the data 32 in the fingerprint authentication database 30.

When a user inputs a fingerprint image to the fingerprint authentication apparatus 200 for authentication, the fingerprint authentication apparatus 200 generates pre-extracted data and feature data from the input fingerprint image. The fingerprint authentication apparatus 200 matches them against the fingerprint authentication data 32 of registered users listed in the fingerprint authentication database 30 and displays whether authentication is successful.

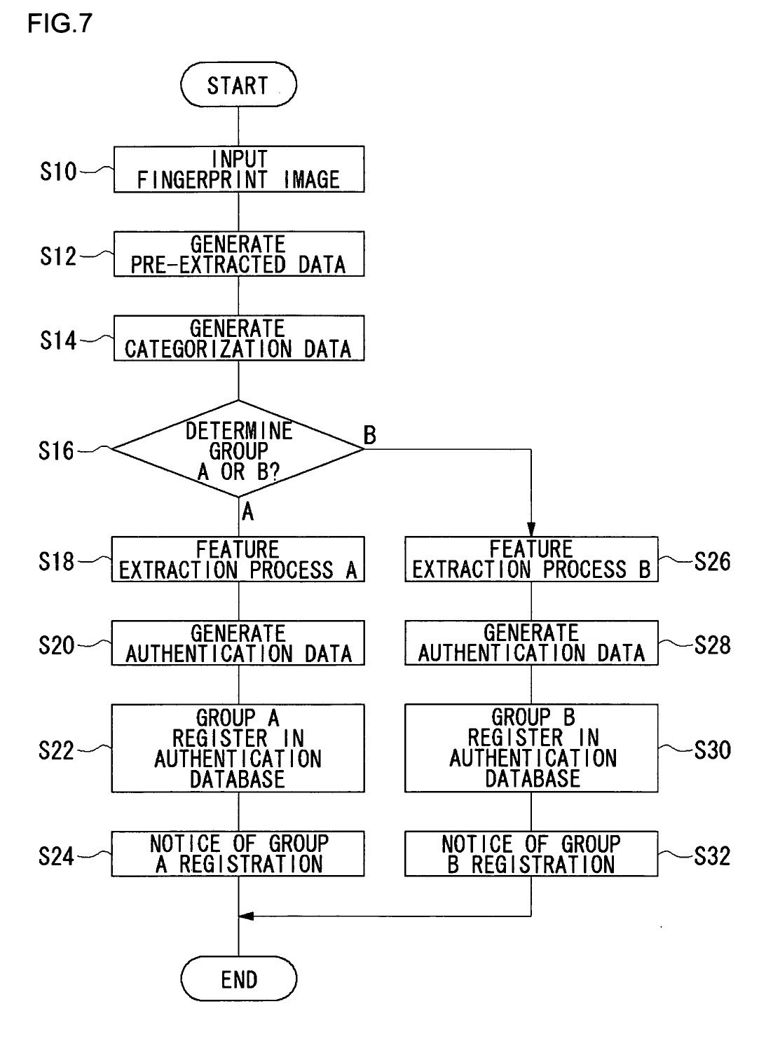

The fingerprint registration procedure and the fingerprint authentication procedure according to the authentication system with the above-described structure will be explained. FIG. 7 is a flowchart showing a procedure for registering a fingerprint in the fingerprint registration apparatus 100. A fingerprint image is input by a user via the input unit 10 of the fingerprint registration apparatus 100 (S10). The pre-extraction and categorization unit 40 generates pre-extracted data from the input fingerprint image (S12) and generates categorization data based upon the pre-extracted data (S14). The switching control unit 12 categorizes the fingerprint image into group A or group B in accordance with the categorization data (S16). If the fingerprint image A is categorized into group A (A in S16), the feature extraction unit 42 subjects the fingerprint image to the feature extraction process A (S18). The authentication data generation unit 18 generates the fingerprint authentication data 32 including the fingerprint feature data and the pre-extracted data thus extracted (S20). The authentication data registration unit 20 registers the fingerprint authentication data 32 in an area of the fingerprint authentication database 30 corresponding to group A (S22). The registration result display unit 22 notifies the user that the fingerprint image is categorized into group A (S24). The unit may not notify the user that the image is categorized into group A. With this, categorization information is prevented from being leaked to somebody else so that security is improved.

If the fingerprint image B is categorized into group B (B in S16), the feature extraction unit 42 subjects the fingerprint image to the feature extraction process B (S26). The authentication data generation unit 18 generates the fingerprint authentication data 32 including the fingerprint feature data and the pre-extracted data thus extracted (S28). The authentication data registration unit 20 registers the fingerprint authentication data 32 in an area of the fingerprint authentication database 30 corresponding to group B (S30). The registration result display unit 22 notifies the user that the fingerprint image is categorized into group B (S32). The unit may not notify the user that the image is categorized into group B. With this, categorization information is prevented from being leaked to somebody else so that security is improved.

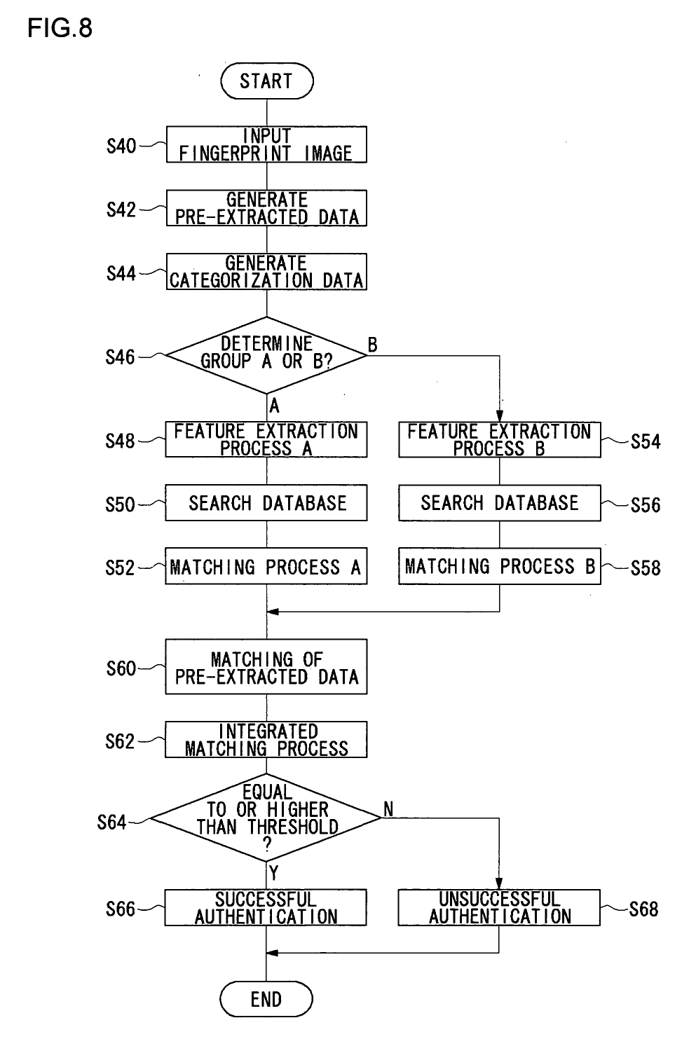

FIG. 8 is a flowchart showing a procedure for authenticating a fingerprint in the fingerprint registration apparatus 200. A fingerprint image is input by a user via the input unit 10 of the fingerprint authentication apparatus 200 (S40). The pre-extraction and categorization unit 40 generates pre-extracted data from the input fingerprint image (S42) and generates categorization data based upon the pre-extracted data. The switching control unit 12 categorizes the fingerprint image into group A or group B in accordance with the categorization data (S46). If the fingerprint image is categorized into group A (A in S46), the feature extraction unit 42 subjects the fingerprint image to the feature extraction process A (S48). The feature data matching processing unit 24 retrieves the fingerprint authentication data 32 from an area of the fingerprint authentication database 30 corresponding to group A (S50) and matches the fingerprint feature data against the fingerprint authentication data 32 (S52). If the fingerprint image is categorized into group B (B in S46), the feature extraction unit 42 subjects the fingerprint image to the feature extraction process B (S54). The feature data matching processing unit 24 retrieves the fingerprint authentication data 32 from an area of the fingerprint authentication database 30 corresponding to group B (S56) and matches the fingerprint feature data against the fingerprint authentication data 32 (S58).

Subsequently, the pre-extracted data matching unit 58 matches the pre-extracted data against the fingerprint authentication data 32 (S60). The integrated authentication unit 60 refers to a result of matching in the feature data matching processing unit 24 and a result of matching in the pre-extracted data matching unit 58 so as to calculate an authentication score (S62). The integrated authentication unit 60 compares the authentication score thus calculated with a predefined threshold for determining whether to permit successful authentication. If the authentication score is equal to or higher than the threshold value (Y in S64), it is determined that the fingerprint to be authenticated matches the fingerprint authentication data, whereupon the user with the fingerprint image is authenticated (S66). Conversely, if the authentication score is lower than the threshold value (N in S64), the user is not authenticated (S68). The above process is repeated for each pair of fingerprint authentication data and fingerprint image, if multiple sets of fingerprint authentication data are registered.

As described above, according to the first embodiment, an input fingerprint image is automatically categorized into one of multiple groups. Fingerprint feature data is extracted by a feature extraction method adapted to the group, resulting in greater convenience to users and high precision in extracting fingerprint feature data. By partitioning the fingerprint authentication database logically or physically into segments defined by categorization data, search efficiency and authentication precision are improved.

By switching between different fingerprint matching algorithms in the feature data matching processing unit in accordance with the categorization data output from the pre-extraction and categorization unit 40, matching is performed using a method adapted for the categorization so that authentication precision is improved. It will also be appreciated that, by allowing the integrated authentication unit to refer to both the result of the second matching process using pre-extracted data and the result of the first matching process using the fingerprint feature data for authentication determination, authentication precision is improved. By weighting the results of the first and second matching processes in accordance with categorization data before calculating authentication scores, influences from the respective matching processes on authentication determination are properly controlled. This reduces the likelihood of biased determination and improves authentication precision.

The first embodiment has been described above by highlighting several examples of practicing the embodiment. The examples are given only by way of illustration and it will be obvious to those skilled in the art that variations in components and processes are possible within the scope of the present invention.

While the above description of the authentication system gives fingerprint authentication as an example, the first embodiment may also be applied to authentication using biometric information such as palm prints, faces, iris, retina, veins and voice prints. For example, in the case of palm prints, rough categorization may be made in accordance with whether a user is an adults or a child or whether a user is a man or a woman. Categorization according to the size of a finger may also be employed. Thereupon, resolution or the like may be optimized in accordance with categorization data. In the case of iris authentication, rough categorization may be made with respect to differences in colors of one's eyes before switching between image processing methods. In the case of voice print authentication, categorization may be made according to the tone of voice, sex, age category (adult or child) or age group before adjusting voice recognition parameters in accordance with categorization data.

In the examples described above, the fingerprint registration apparatus 100 and the fingerprint authentication apparatus 200 are formed as separate structures. Alternatively, the apparatuses may be integrated by allowing the fingerprint authentication apparatus 200 to include the functions and structure of the fingerprint registration apparatus 100. In this case, the apparatuses can share structures including the input unit 10, the switching control unit 12, the switches 14a and 14b, the pre-extraction and categorization unit 40 and the feature extraction unit 42. Consequently, the structure of the authentication system is simplified.

In the examples, the feature extraction process A and the feature extraction process Bare defined as feature extraction algorithms in the feature extraction unit 42 available for selection in accordance with categorization data. Alternatively, three or more feature extraction processes may be defined. For example, multiple categorization data sets may be defined depending on the width of a window in which fingerprint feature data is extracted so that the feature extraction unit 42 executes a feature extraction process in accordance with the categorization data. According to this variation, feature extraction processes more suitable for fingerprint images are performed. Similarly, three or more matching processes in the feature data matching processing unit may be defined depending on the number of categorization data sets. According to this variation, matching processes more suitable for fingerprint images can be performed so that authentication precision is improved.

### Embodiment 2

### Background of this Embodiment

Recently, fingerprint authentication systems are used in wide applications including entrance control, computer log in and permission of use of mobile equipment such as a cell phone. In association with the variety of such applications and environments in which the systems are used, various authentication technologies are proposed addressing different requirements for matching precision, computational load, privacy protection, etc.

Related-art fingerprint authentication methods are roughly categorized into (a) the minutiae-based method; (b) the pattern matching method; (c) the chip matching method; and (d) the frequency analysis method. (a) In the minutiae-based method, characteristic points such as ridge endings or ridge bifurcations (minutiae) are extracted from a fingerprint image. By comparing two fingerprint images for information on these points, fingerprints are matched for authentication of a user.

(b) In the pattern matching method, direct comparison is made between the patterns of two fingerprint images for fingerprint matching so as to determine whether a legitimate user is accessing. (c) In the chip matching method, an image of a small area surrounding a feature point (i.e. a chip image) is maintained as registered data. Fingerprint matching is performed using a chip image. (d) In the frequency analysis method, lines obtained by slicing a fingerprint image are subject to frequency analysis. Fingerprint matching is performed by comparing frequency component distributions in two fingerprint images occurring in a direction perpendicular to the direction of slicing.

JP 10-177650 discloses a technology in which feature vectors are extracted from an image showing a skin pattern, reliability information relative to the feature vectors are at least used as a feature index necessary for matching, and consistency between images is determined by calculating similarity between images to be checked for matching.

In minutiae-based matching based upon extracted feature points, a determination of matching failure may be made due to a slight difference in distance between points that are actually counterparts in respective fingerprint images. A determination of successful matching between feature points that actually do not match may also be made depending on the condition of imaging. When these occur, matching precision is lowered. In this background, there is proposed a minutiae relation method in which the number of ridges located between feature points is obtained and included in information subject to comparison in order to improve in matching precision. Meanwhile, there is still a problem in that an incorrect number of ridges may be obtained due to blurred ridges in a captured image. In addition, it is quite likely that the numbers of ridges match by chance when actually the feature points are not counterparts. When these occur, improvement in precision cannot be hoped for.

### Summary of this Embodiment

A second embodiment of the present invention addresses the circumstances as described above and its general purpose is to provide a matching method and a matching apparatus embodying a highly precise matching technology based upon feature points.

A matching method according to the second embodiment comprises: extracting a plurality of feature points from a reference image referred to in matching, in accordance with a predetermined rule; generating feature point pairs from the plurality of feature points; calculating a gradient vector between predetermined pixel values of pixels located between the feature point pairs; obtaining gradient information relating to a predetermined attribute, by using the gradient vector; and registering feature information characterizing the feature points forming a pair and the gradient information occurring between the pairs in relation to each other.

A target image may be an image of a body such as an image of a fingerprint, an image of a palm, an image of finger veins and a face image. Therefore, in the case of a fingerprint image or a vein image, a feature point may be any point of characteristic configuration such as a ridge bifurcation, a ridge ending, a vein bifurcation or a vein ending. In the case of a face image, any characteristic point in facial features such as the inner corners of one's eye, the corner of one's mouth and the end of one's eyebrow may serve as a feature point. Any attribute representable by a gradient vector, such as the direction of a ridge or vein located between feature points, skin chromaticity and skin density, may be included in information subject to comparison in a matching process.

The matching method may further comprise: extracting a plurality of feature points from an image to be checked for matching, in accordance with a predetermined rule; detecting, from the plurality of feature points, feature point pairs corresponding to the feature point pairs in the reference image; calculating a gradient vector between predetermined pixel values of pixels intervening between the feature point pairs; obtaining gradient information relating to a predetermined attribute, by using the gradient vector; and matching the reference image against the image to be checked for matching, by using the gradient information.

Another matching method according to the second embodiment comprises: extracting a plurality of feature points from a fingerprint image to be referred to in matching, in accordance with a predetermined rule; generating feature point pairs from the plurality of feature points in the reference fingerprint image; obtaining gradient information representing directions of ridges located between the feature point pairs in the reference fingerprint image; registering feature information characterizing the feature points forming a pair in the reference fingerprint image and the gradient information occurring between the pairs in relation to each other; extracting a plurality of feature points from a fingerprint image to be checked for matching according to a predetermined rule; detecting, from the plurality of feature points in the fingerprint image to be checked for matching, feature point pairs corresponding to the feature point pairs in the reference fingerprint image; obtaining gradient information representing directions of ridges located between the feature point pairs detected in the fingerprint image to be checked for matching; and matching the reference fingerprint image against the fingerprint image to be checked for matching, by using the gradient information.

A matching apparatus according to the second embodiment comprises: an imaging unit which captures a biometric image; a feature point extraction unit which extracts multiple feature points from the captured biometric image according to a predetermined rule; an operation unit which obtains gradient information relating to a predetermined attribute occurring between the feature point pairs; and a matching unit which matches an image to be checked for matching and a reference image, by using the gradient information.

A time interval may occur between imaging of a reference image and imaging of an image to be checked for matching. Alternatively, imaging may take place successively. When capturing a reference image prior to authentication, gradient information may be captured concurrently.

The matching apparatus may further comprise a storage unit which stores feature information characterizing the feature points forming a pair in the reference image and the gradient information occurring between the pairs in relation to each other. “Feature information on a feature point” may be information characteristic of a feature point itself, such as the position of a feature point, the direction of a feature point, the type of a feature point and the density of ridges located in the neighborhood of a feature point.

Optional combinations of the aforementioned components, and implementations of the second embodiment in the form of methods, apparatuses, systems, computer programs and recording mediums may also be practiced as additional modes of the second embodiment.

### EXAMPLE 1

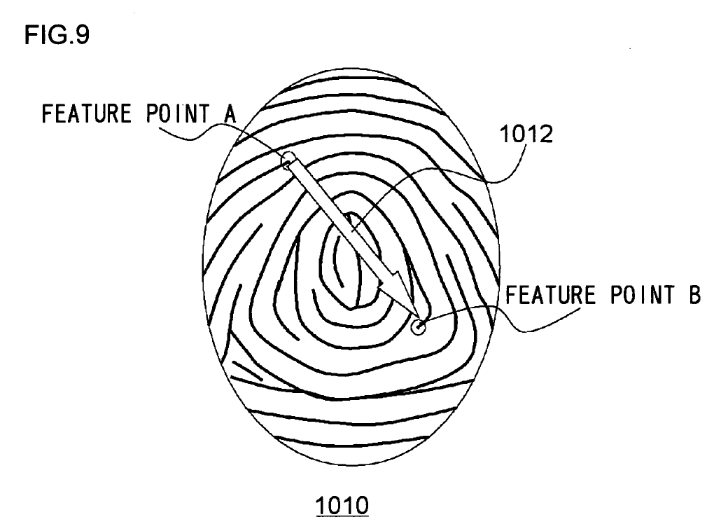

A summary of a first example of practicing the second embodiment will be given. FIG. 9 is a schematic view showing feature points in a fingerprint image. A fingerprint 1010 includes representative feature points A and B extracted by a method such as the minutiae-based method. In the second embodiment, direction vectors representing ridges which cross a line connecting the feature points thus extracted are analyzed for their distribution along the line so as to generate data to be authenticated. Authentication is performed by matching pre-registered reference image data against the data of an image to be authenticated captured in an imaging process initiated by a user requesting authentication. The coordinate axis formed by a line connecting the feature point A and the feature point B is indicated by an arrow 1012 in FIG. 9. A direction vector is broadly defined as a vector that represents the direction of a ridge either directly or indirectly.

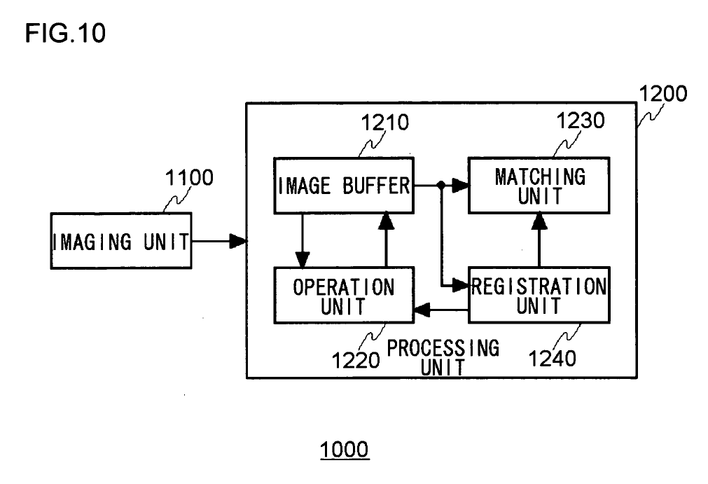

A description will be given of the structure according to the first example of practicing the second embodiment. FIG. 10 is a functional block diagram of a matching apparatus 1000. The blocks as shown may be implemented by hardware including components such as a processor, a RAM, etc. and devices such as a sensor. The blocks may also be implemented by software including a computer program. FIG. 10 depicts functional blocks implemented by cooperation of hardware and software. Therefore, it will be obvious to those skilled in the art that the functional blocks may be implemented by a variety of manners by a combination of hardware and software.

The matching apparatus 1000 is provided with an imaging unit 1100 and a processing unit 1200. The imaging unit 1100, which comprises a charge coupled device (CCD) or the like, captures an image of a user's finger and outputs the image to the processing unit 1200. For example, the user may hold his or her finger over a CCD-based line sensor built in a mobile appliance. A fingerprint image is captured by sliding the finger in a direction perpendicular to the line sensor.

The processing unit 1200 includes an image buffer 1210, an operation unit 1220, a matching unit 1230 and a registration unit 1240. The image buffer 1210 is a memory area used to temporarily store image data from the imaging unit 1100 or used as a work area of the operation unit 1220. The operation unit 1220 analyzes the image data in the image buffer 1210 and performs various operations described later. The matching unit 1230 compares a feature index of the image data to be authenticated stored in the image buffer 1210 with a feature index of image data stored in the registration unit 1240 so as to determine whether the fingerprints belong to the same person. The registration unit 1240 registers as reference data a feature index of a fingerprint image captured. When implemented in cell phones, the registration unit 1240 may register data for a single person in a majority of cases. In applications like entrance control at a gate or the like, data for multiple persons may usually be registered.

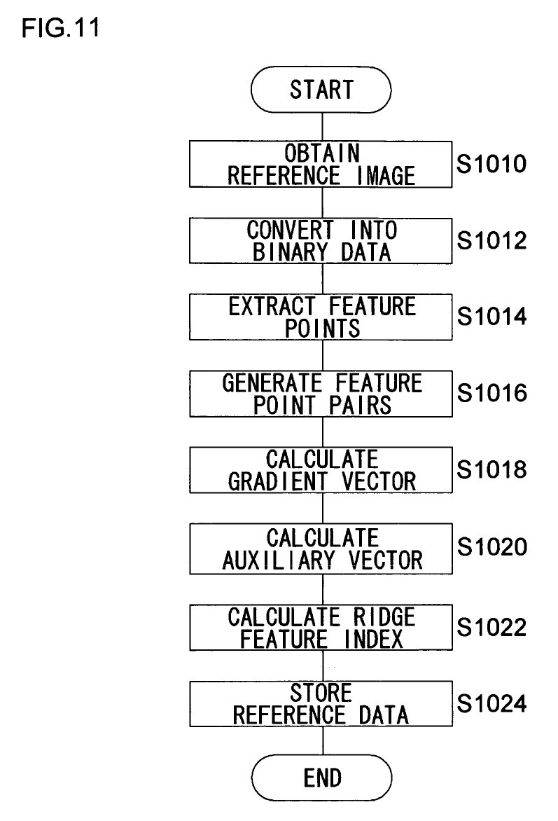

FIG. 11 is a flowchart showing a process for generating reference data for use in the matching apparatus 1000. The reference data includes a feature index of a feature point such as a ridge ending and a ridge bifurcation in a fingerprint image of a person to be authenticated. The data also includes the distribution of feature indexes that characterizes the directions of ridges located between a pair of feature points.

The imaging unit 1100 captures an image of a finger of a user held over the imaging unit 1100 and converts the captured image into an electric signal for output to the processing unit 1200. The processing unit 1200 obtains the signal as image data and temporarily stores the data in the image buffer 1210 (S1010). The operation unit 1220 converts the image data into binary data (S1012). For example, if a data value exceeds a predetermined threshold value in brightness, it is determined that the data indicates white. If not, the data is determined to indicate black. By representing white as 1 or 0 and black as 0 or 1, binary data is obtained.

Subsequently, the operation unit 1220 extracts feature points such as a ridge ending or a ridge bifurcation from binarized image data (S1014). For extraction of feature points, steps that are generally used in the minutiae-based method are employed. For example, the number of connections with surrounding pixels is determined, while tracking pixels of 0 or 1 indicating a ridge in the binarized image. Pixel-by-pixel determination is made as to whether an ending or a bifurcation is found in accordance with the number of connections. Each time a feature point is extracted, the feature indexes of the feature, such as the type, coordinate etc. of the feature, are stored in the image buffer 1210.

Subsequently, at least one pair of feature points is generated from the multiple feature points thus extracted (S1016). All of the feature points extracted in S014 may constitute pairs. Alternatively, pairs may be generated by extracting some of the feature points according to a predetermined rule. According to the first example of practicing the second embodiment, feature indexes representing ridges between two feature points are used for authentication. Therefore, if the two feature points are in close proximity, resultant information is low in volume and the contribution thereof to the intended effects is relatively small. In this respect, a predetermined threshold value representing a distance between feature points may be established so that pairs of feature points at a distance equal to or larger than the threshold value may be generated. The threshold value may be determined from the perspective of precision and computational load, by repeating authentication experiments.

Subsequently, the system sequentially calculates gradient vectors indicating gradients between pixel values occurring in an image area having at its center a pixel located on a line connecting the pair of feature points generated in S1016, the calculation being done along the line (S1018). In calculating gradient vectors, a method for calculating density gradient generally used in edge detection in a multi-valued image may be employed. Such a method is described, for example, in “Computer Image Processing, Hideyuki Tamura, Ohmsha, Ltd., pp. 182-191.”

A brief description will now be given of the method. For calculation of gradient in a digital image, it is necessary to induce first-order partial differentiation in the x direction and in the y direction.
Δₓf(i,j)≡{f(i+1,j)−f(i−1,j)}/2 (1)
Δ_{y}f(i,j)≡{f(i,j+1)−f(i,j−1)}/2 (2)

By using a differential operator, a derivative at a pixel at (i, j) in a digital image is defined as a linear combination of pixel values of pixels in a 3×3 array around the pixel at (i, j). More specifically, the derivative is defined as a linear combination of f(i−1, j−1), f(i, j−1), f(i+1, j−1), f(i−1, j), f(i, j), f(i+1, j), f(i−1, j+1), f(i, j+1), f(i+1, j+1). This means that calculation for determining derivatives in an image is achieved by using spatial filtering that uses a 3×3 weighting matrix. Various differential operators are represented by 3×3 weighting matrixes. In the following description, it will be assumed that the pixel at (i, j) and the surrounding pixels in the 3×3 array are denoted by expression (3). A differential operator is described as a weighting matrix applied to the pixels.

$$\begin{matrix}f ( i - 1 , j - 1 ) & f ( i , j - 1 ) & f ( i + 1 , j - 1 ) \\ f ( i - 1 , j ) & f ( i , j ) & f ( i + 1 , j ) \\ f ( i - 1 , j + 1 ) & f ( i , j + 1 ) & f ( i + 1 , j + 1 )\end{matrix} \qquad ( 3 )$$

For example, the first-order differential operators in the x and y directions defined by expressions (1) and (2) are represented as follows.

$$\begin{matrix}0 & 0 & 0 \\ - 1 / 2 & 0 & 1 / 2 \\ 0 & 0 & 0\end{matrix} \\ and \\ \begin{matrix}0 & - 1 / 2 & 0 \\ 0 & 0 & 0 \\ 0 & 1 / 2 & 0\end{matrix} \qquad ( 4 )$$

That is, products between pixel values and corresponding element values in a matrix is obtained in a 3×3 rectangular area represented by expressions 3 and 4. Calculation of a sum of the products yields the same result as given on the right-hand side of expressions 1 and 2.

As a result of spatial filtering using a weighting matrix of expression (4) and calculating partial derivatives in the x and y directions as defined in expressions (1) and (2), the magnitude and direction of gradients are determined as given below.
|∇f(i,j)|=√{Δₓf(i,j)²+Δ_{y}f(i,j)^{2}} 5
θ=tan⁻¹{Δ_{y}f(i,j)/Δₓf(i,j)} (6)

A Roberts operator, a Brewitt operator or a Sobel operator may be used as a differential operator. In this way, the operator is calculated in a simplified fashion and noise is effectively removed as well.

The operation unit 1220 obtains the x component and the y component of a vector by doubling the angle (i.e. the orientation with respect to the coordinate axis of the gradient determined by expression (6)) of the gradient vector (S1020). Hereinafter, such a vector will be referred to as an auxiliary vector. In the first example, numerical values representing the directions of ridges are calculated by using gradient vectors. At the two boundaries of a black area indicating a ridge, the directions of gradient vectors are opposite to each other. If no countermeasures are introduced, problems may occur such as cancellation of directional components upon calculation of a sum for determining an average value. In this case, complex compensation measures are necessary to address the fact that 180° and 0° are equivalent. Thus, by deriving auxiliary vectors oriented in the same direction at the borders of a ridge as described above, subsequent calculation is simplified. For example, in the case of a ridge having borders represented by direction vectors with angles of 45° and 225°, respectively, the angles of the auxiliary vectors are 90° and 450°, respectively, which indicate a unique direction.

Subsequently, the operation unit 1220 refers to the distribution of auxiliary vectors along the line connecting the feature points, as obtained in S1020, so as to calculate the position of ridges crossing the line as well as calculating the x components and the y components of direction vectors representing the ridges (S1022). The position of a ridge is represented by a distance from a reference feature point constituting the pair. A reference feature point may be determined in advance according to a predetermined rule. For example, one of the two feature points with smaller x coordinate may be selected. A direction vector representing the direction of a ridge may be calculated by strictly referring to an auxiliary vector. Alternatively, the values of the auxiliary vector may be employed unmodified in order to determine a direction vector (hereinafter, vectors thus obtained will be generically referred to as direction vectors).

Finally, the operation unit 1220 relates the feature point pairs to the distribution of the components of the direction vectors representing ridges and stores a resultant ridge feature index table in the registration unit 1240 as reference data (S1024). The feature indexes of the feature points, such as the type, coordinate, orientation and the like of all the feature points extracted by the ordinary minutiae-based method in S1014, are stored in the registration unit 1240 as a feature point feature table. The operation unit 1220 may apply a smoothing process described later to the distribution of the components of the direction vectors before storing the data.

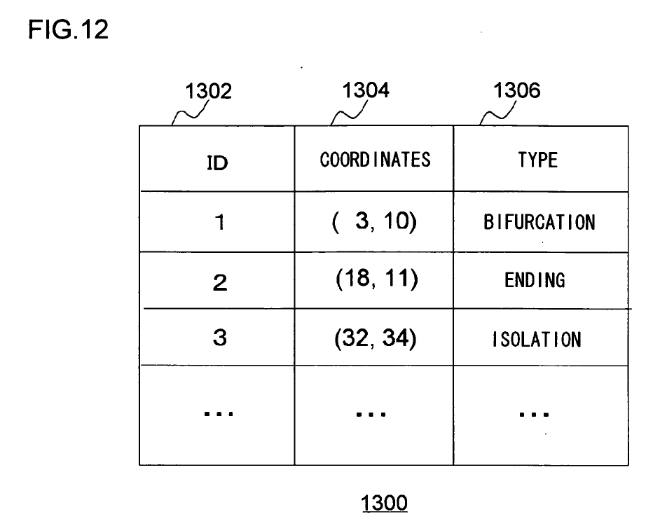

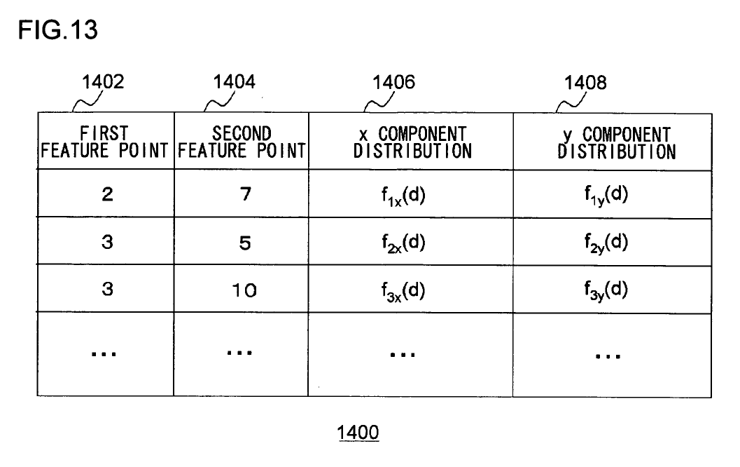

FIGS. 12 and 13 each show the data structure of two types of tables stored in the registration unit 1240. The feature table 1300 shown in FIG. 12 includes an ID column 1302, a coordinate column 1304 and a type column 1306. All of the features extracted in S1014 are assigned identification numbers which are registered in the ID column 1302. The coordinates of the feature points with respect to the reference point and the types of the feature points are registered in the coordinate column 1304 and the type column 1306, respectively. Feature indexes other than the coordinate and type may also be stored in additional columns in the table. The ridge feature index table shown in FIG. 13 includes a first feature point column 1402, a second feature point column 1404, an x component distribution column 1406 and a y component distribution column 1408. The identification numbers of the first feature and second feature points constituting the pair generated in S1016 of FIG. 11 are registered in the first feature point column 1402 and the second feature point column 1404, respectively. The functions fₙₓ(d) and f_{ny}(d) representing the x component and the y component of the direction vectors of ridges that cross the line connecting the first and second feature points, using a distance d from the first feature point as a parameter, are registered in the x component column 1406 and the y component column 1408, respectively, where n denotes a natural number. In practice, the function fₙₓ (d) may be represented by a list comprising the value of the x component of the direction vector and the distance d, and the function f_{ny} (d) may be represented by a list comprising the value of the y component of the direction vector and the distance d.

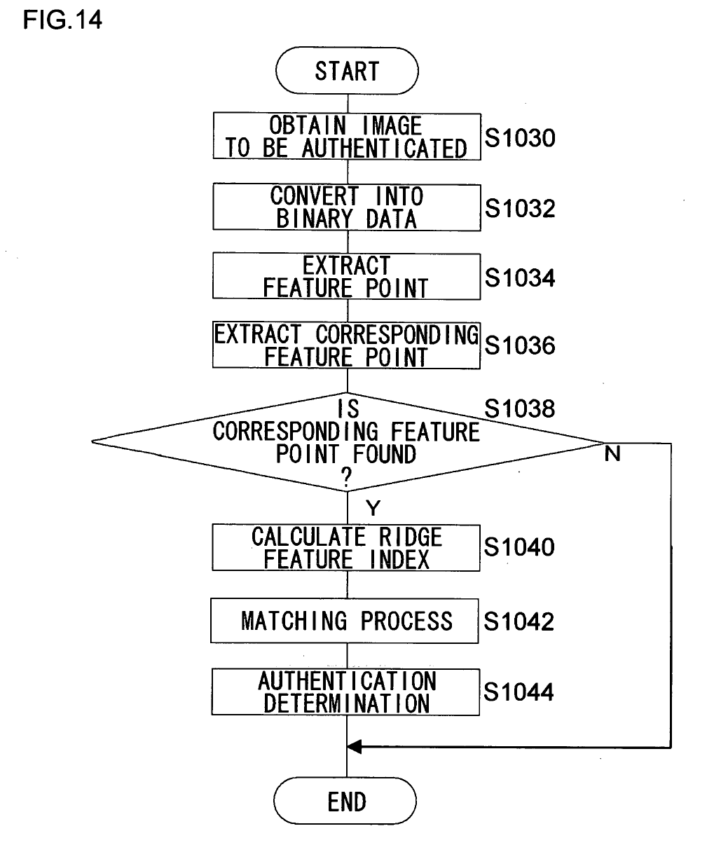

FIG. 14 is a flowchart for an authentication process in the matching apparatus 1. Similarly to the case of a reference image, the imaging unit 1100 captures an image of a finger that a user requesting authentication holds over the imaging unit 1100 and converts the captured image to be authenticated into an electrical signal for output to the processing unit 1200. The processing unit 1200 obtains the signal as image data and temporarily stores the same in the image buffer 1210 (S1030). The operation unit 1220 converts the image data into binary data (S1032) and extracts feature points such as endings and bifurcations (S1034). In this process, each time a feature point is extracted, the feature indexes of the feature, such as the type, coordinate etc. of the feature, are stored as is done in the case of the reference image.

Subsequently, the matching unit 1230 refers to feature indexes such as the coordinate of a feature point in an image to be authenticated extracted by the operation unit 1220 in S1034, so as to identify a corresponding feature point in the reference image listed in the feature point feature table 1300 for the reference image stored in the registration unit 1240 (S1036). If a corresponding feature point is not identified (N in S1038), it is determined that authentication has failed and the process is completed. If a corresponding feature point is identified (Y in S1038), the operation unit 1220 refers to the feature point feature table 1300 and the ridge feature index table 1400 so as to identify a corresponding feature point forming a pair, based upon the identification number. The operation unit 1220 then generates a pair of corresponding feature points in the image to be authenticated. The operation unit 1220 then calculates the distribution of the components of the direction vectors representing intervening ridges through processes similar to those applied to the reference image (i.e., the processes in S1018, S1020 and S1022 of FIG. 11) (S1040). The distribution of direction vectors may be subject to a smoothing process.

The operation unit 1220 matches the reference image against the image to be authenticated by referring to the feature indexes of the features and to the distributions of the direction vectors representing ridges (S1042). The matching between the feature indexes of the feature points is done using the ordinary minutiae-based method. The distribution of the direction vectors representing ridges may be matched against one another using a pattern matching approach described below. All of the pairs of feature points for which the distribution is calculated are subject to pattern matching. Initially, interest points in two corresponding distributions are detected. The corresponding interest points and the distribution in their neighborhood are subject to matching. An interest point may be a point where one of the component values is at maximum, a point where one of the component values is 0, a point where a derivative is 0 or a point with highest gradient.

Matching is performed by detecting a difference between a reference image and an image to be authenticated in respect of the distribution of direction vectors. The detection is done at points with a distance d from the first feature point. For example, the following expression (7) may be used to calculate the energy E of matching.
E=Σ√{Δfₙₓ(d)^{2+Δ}f_{ny}(d)^{2}} (7)

where Δfₙₓ (d) and Δf_{ny} (d) denote a difference in x components and a difference in y components, respectively. The matching energy E is a product of the distance d from the first feature point by the magnitude of an error vector. The higher the matching energy E, the larger an error between distributions. The smaller the matching energy, the closer the distributions are. The relative positions of the distribution patterns are adjusted by shifting the patterns in such a way as to minimize the matching energy E. Other pattern matching methods may also be employed. For example, a sum of the absolute values of the errors Δ fₙₓ (d) in x components and a sum of the absolute values of the errors Δ f_{ny} (d) in y components may be obtained. Alternatively, a matching method that yields high precision may be determined experimentally and used.

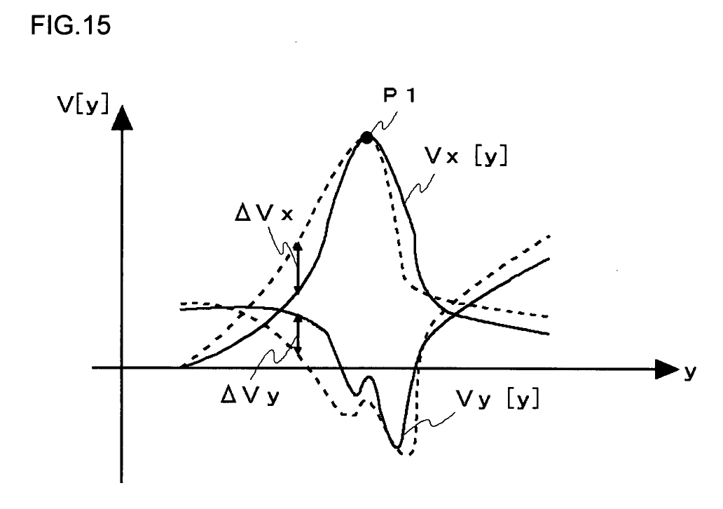

FIG. 15 is a graph showing how the above-described pattern matching is applied to the direction vector distribution in a reference image and in an image to be authenticated. In this graph, the distributions of x and y components of the direction vectors in a reference image are indicated by solid lines and those of an image to be authenticated are indicated by broken lines. In the illustrated example, the maximum values of the x component in both distributions are detected. Pattern matching is performed when the relative positions of the graphs are such that the maximum values p1 are plotted at the same position and also when one of the graphs (i.e. the pattern of the reference image or the pattern of the image to be authenticated) is shifted by a predetermined infinitesimal distance in both directions. The relative positions that produce the minimum matching energy E are determined as positions where the graphs should be superimposed.

Referring back to FIG. 14, the matching unit 1230 performs authentication by referring to the minimum value of the matching energy E thus calculated and in accordance with a criterion employed in the ordinary minutiae-based method in connection with feature indexes of a features (S1044). For example, the number of corresponding feature points extracted in S1036 may be employed as the criterion. For example, authentication is determined to be successful when the number of feature points is equal to or greater than a predetermined number and the average of the minimum values of matching energy is equal to or lower than a predetermined value.

According to the first example of practicing the second embodiment, pairs are formed of feature points extracted by a related-art method. For each pair of feature points thus formed, information relating to the distribution of the directions of intervening ridges is obtained and used for authentication. According to this approach, the amount of information available is increased considerably with a relatively small increase in computational load. As compared to an approach in which feature points are evaluated individually, matching precision is improved. Highly precise matching is possible even with a fingerprint having relatively few feature points. In comparison with an approach in which merely the numbers of ridges between feature points are compared, the likelihood that patterns match each other accidentally is low since the direction of ridges is of interest. Moreover, since the distribution is taken into account, precision is affected only slightly even if images of some ridges are blurred. The extent to which the feature index of a feature is used in authentication can be determined depending upon the situation, allowing for requirements for both precision and computational load. Therefore, operations adapted to the user's needs are achieved.

### EXAMPLE 2

In the first example of practicing the second embodiment, a direction vector representing a ridge is represented by a function f (d) and the distribution thereof along a line connecting a pair of feature points is identified. Pattern matching is performed by comparing a reference image and an image to be authenticated. In the second example of practicing the second embodiment, average values of the direction vectors of ridges are compared.

The second example of practicing the second embodiment is also implemented by the matching apparatus 1 of FIG. 10 showing the first example of practicing the second embodiment. Generation of reference data and authentication are performed according to a procedure similar to that of FIGS. 11 and 14. The following description primarily concerns a difference from the first example.

The second example of practicing the second embodiment differs from the first example in S1022 of FIG. 11, i.e., the step of calculating the feature index of a ridge. The x component and the y component of a direction vector representing a ridge are calculated ridge by ridge, based upon the distribution of auxiliary vectors along a line connecting a pair of feature points. Similarly to the first example, the direction vector thus calculated may be a vector representing the actual direction of the ridge or an auxiliary vector. Thereupon, average values of the directional components representing all ridges are calculated according to expressions (8) and (9) below.
fₓ_{_{—}}ₐᵥₑ=Σfₓ(s)/t (8)
f_{y}_{_{—}}ₐᵥₑ=Σf_{y}(s)/t (9)

where s denotes a natural number identifying a ridge, and t denotes the number of ridges. Given that s=1, 2 . . . , 1≦s≦t. Σ is to obtain a sum for all natural numbers s.

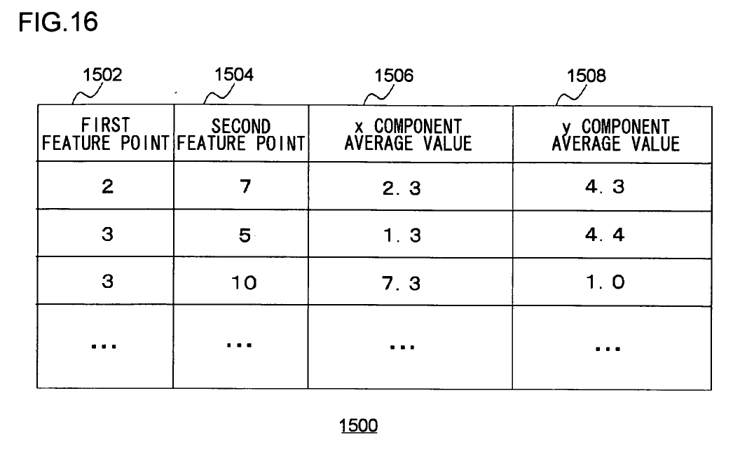

FIG. 16 shows the data structure of a ridge feature index table stored in the registration unit 1240 in accordance with the second example of practicing the second embodiment and constituting the reference data. The ridge feature index table 1500 includes a first feature point column 1502, a second feature point column 1504, an x component average value column 1506 and a y component average value column 1508. As in the first example of practicing the second embodiment, the identification numbers identifying the first feature point and the second feature point forming a pair are registered in the first feature point column 1502 and the second feature point column 1504, respectively. In the second example of practicing the second embodiment, the average values calculated according to expressions (8) and (9) are registered in the x component average value column 1506 and the y component average value column 1508, respectively. That is, a subject of comparison in the second example is a pair of x component and a y component.

Similarly, in authentication, the average value representing the direction vectors representing ridges is calculated for each directional component in S1040 of FIG. 14, i.e. in the step for calculating the feature indexes of ridges. In the matching process in S1042 of FIG. 14, the average value of the direction vectors in an image to be authenticated is compared with the average value of the corresponding direction vectors in a reference image. The comparison is done for all pairs of feature points and for each directional component. For example, the differences between the average values from respective images are averaged over the entirety of feature point pairs. Subsequently, in S1044 of FIG. 14, i.e., in the authentication determination step, authentication determination is performed by referring to the averaged values and in accordance with a criterion employed in the ordinary minutiae-based method in connection with feature indexes of features. According to the second example of practicing the second embodiment, an average value is determined from the distribution of the direction vectors representing ridges. Therefore, some information, including the position of ridges and the number of ridges obtained in the process of determining the distribution, etc., remains unused in authentication. Depending on requirements for authentication precision and computational load, such information may also be incorporated for authentication determination allowing for multiple factors.

Similar to the first example of practicing the second embodiment, the second example forms pairs of feature points extracted in a related-art method. For each pair of feature points thus generated, information related to the direction of intervening ridges is obtained and used for authentication. Thus, as compared to an approach in which feature points are evaluated individually, matching precision is improved. Since operation for pattern matching between distributions is not necessary, the required computational load is reduced as compared to the first example. Since there is no need to store distribution data as reference data, the second example is useful for authentication in, for example, a mobile appliance in which computational load should be reduced and memory resources should be saved.

Described above are some examples of practicing the second embodiment. The examples described are illustrative in nature and it will be obvious to those skilled in the art that various variations in constituting elements etc. are possible within the scope of the second embodiment.

For example, a direction vector representing a ridge may not be defined in a Cartesian coordinate system comprising an x axis and a y axis. For example, the vector may be defined in a coordinate system comprising a line connecting feature points forming a pair and an axis perpendicular to the line. In this case, the same workings and effects as achieved in the first and second examples are achieved.

In the above-described embodiment, the distribution of direction vectors representing ridges of a fingerprint or an average value representing the distribution is used for authentication. Furrows of a fingerprint may also be used for authentication. In the case of vein authentication, feature points are extracted as in fingerprint authentication. Pairs of feature points are formed so as to calculate the distribution of direction vectors representing intervening veins or the average values of the vectors. In the case of face authentication, the inner corners of one's eye may be designated as feature points and the distribution of gradient vectors representing density gradient in the skin is calculated as a feature index in the intervening area. In either case, improvement in authentication precision is achieved similarly to the first and second examples. The mode of operation may be selected depending upon the situation, allowing for requirements for precision and computational load.

The second embodiment encompasses methods and apparatuses as defined in 1 through 11 below.

1. A matching method comprising: extracting a plurality of feature points from a reference image referred to in matching, in accordance with a predetermined rule; generating feature point pairs from the plurality of feature points; calculating a gradient vector between predetermined pixel values of pixels located between the feature point pairs; obtaining gradient information relating to a predetermined attribute, by using the gradient vector; and registering feature information characterizing the feature points forming a pair and the gradient information occurring between the pairs in relation to each other.

2. The matching method according to 1, further comprising: extracting a plurality of feature points from an image to be checked for matching, in accordance with a predetermined rule; detecting, from the plurality of feature points, feature point pairs corresponding to the feature point pairs in the reference image; calculating a gradient vector between predetermined pixel values of pixels intervening between the feature point pairs; obtaining gradient information relating to a predetermined attribute, by using the gradient vector; and matching the reference image against the image to be checked for matching, by using the gradient information.

3. The matching method according to 2, wherein the images are fingerprint images, and the obtaining of the gradient information includes obtaining gradient information representing directions of ridges located between a pair feature points in a fingerprint, and the matching includes using the gradient information representing directions of ridges.

4. The matching method according to 2 or 3, wherein the matching includes matching using feature information on the plurality of feature points in addition to the gradient information.

5. A matching method comprising: extracting a plurality of feature points from a fingerprint image to be referred to in matching, in accordance with a predetermined rule; generating feature point pairs from the plurality of feature points in the reference fingerprint image; obtaining gradient information representing directions of ridges located between the feature point pairs in the reference fingerprint image; registering feature information characterizing the feature points forming a pair in the reference fingerprint image and the gradient information occurring between the pairs in relation to each other; extracting a plurality of feature points from a fingerprint image to be checked for matching according to a predetermined rule; detecting, from the plurality of feature points in the fingerprint image to be checked for matching, feature point pairs corresponding to the feature point pairs in the reference fingerprint image; obtaining gradient information representing directions of ridges located between the feature point pairs detected in the fingerprint image to be checked for matching; and matching the reference fingerprint image against the fingerprint image to be checked for matching, by using the gradient information.

6. A matching apparatus comprising: an imaging unit which captures a biometric image; a feature point extraction unit which extracts multiple feature points from the captured biometric image according to a predetermined rule; an operation unit which obtains gradient information relating to a predetermined attribute occurring between the feature point pairs; and a matching unit which matches an image to be checked for matching and a reference image, by using the gradient information.

7. The matching apparatus according to 6, further comprising a storage unit which stores feature information characterizing the feature points forming a pair in the reference image and the gradient information occurring between the pairs in relation to each other.

8. The matching apparatus according to 7, wherein the operation unit refers to the feature information characterizing the feature points in the reference image stored in the storage unit, detects, from the feature points in the image to be checked for matching, feature point pairs corresponding to the feature point pairs in the reference image, and obtains the gradient information occurring between the detected feature point pairs.

9. The matching apparatus according to 7, wherein the matching unit performs matching by using the feature information characterizing the feature points, in addition to using the gradient information.

10. The matching apparatus according to any one of 6 through 9, wherein the operation unit calculates a gradient vector between predetermined pixel values of pixels located between the feature point pairs and obtains the gradient information based upon the gradient vector thus calculated.

11. The matching apparatus according to any of 6 through 10 above, wherein the biometric image is a fingerprint image, the operation unit obtains distribution of direction vectors representing directions of ridges located between feature point pairs in a fingerprint, and the matching unit performs matching by using the distribution of the direction vectors.

### Background of this Embodiment

Recently, mobile appliances such as cell phones with a built-in fingerprint authentication system are available. Compared with desktop personal computers and large-scale systems, more severe constraints in respect of memories and CPU performance are imposed on a mobile appliance. Therefore, an authentication method that can be implemented using a relatively small amount of memory and an inexpensive CPU is desired.

In mobile appliances as mentioned above, constraints on an area in which a fingerprint sensor is mounted are relatively severe. Therefore, a sweep sensor fingerprint authentication apparatus, which obtains a fingerprint image by allowing a user to slide his or her finger over a line sensor, instead of an area sensor used in the related art, is widely used. A sweep sensor fingerprint authentication apparatus is favorable in terms of fabrication cost.

Related-art fingerprint authentication methods are roughly categorized into (a) the minutiae-based method; (b) the pattern matching method; (c) the chip matching method; and (d) the frequency analysis method. (a) In the minutiae-based method, characteristic points such as ridge endings or ridge bifurcations (minutiae) are extracted from a fingerprint image. By comparing two fingerprint images for information on these points, fingerprints are matched for authentication of a user.

(b) In the pattern matching method, direct comparison is made between the patterns two fingerprint images for fingerprint matching so as to determine whether a legitimate user is accessing. (c) In the chip matching method, an image of a small area surrounding a feature point (i.e. a chip image) is maintained as registered data. Fingerprint matching is performed using a chip image. (d) In the frequency analysis method, lines obtained by slicing a fingerprint image are subject to frequency analysis. Fingerprint matching is performed by comparing frequency component distributions in two fingerprint images occurring in a direction perpendicular to the direction of slicing.

JP 10-177650 discloses a technology in which feature vectors are extracted from an image showing a skin pattern, reliability information relative to the feature vectors are at least used as a feature index necessary for matching, and consistency between images is determined by calculating similarity between images to be checked for matching.

(a) The minutiae-based method and (c) the chip matching method require pre-processing that involves concatenation of isolated portions of a captured image and demand an increased computational volume. In the (b) pattern matching method, data for a whole image should be stored so that the volume of data to be stored will be increased if data for a large number of people is registered. (b) The frequency analysis method requires frequency conversion so that computational volume is increased accordingly. The teaching of patent document No. 1 also requires statistical analysis so that computational volume is increased accordingly.

In a sweep sensor fingerprint authentication apparatus, a fingerprint image is built from a series of images captured by a line sensor so that various authentication methods are applied to the image built. We have discovered that an error may be introduced in building a fingerprint image and, as a result, it may sometimes be difficult to insure satisfactory matching precision on a constant basis.

### Summary of this Embodiment

A primary purpose of the third embodiment in this background is to provide a matching method and a matching apparatus capable of performing matching using a relatively smaller amount of memory and requiring a relatively small computational volume. An additional purpose of the third embodiment is to provide a matching method and a matching apparatus with higher matching precision.

The matching method according to the third embodiment comprises: obtaining a numerical distribution of a plurality of attributes in a biometric image; correcting the numerical distribution of one of the plurality of attributes by the numerical distribution of a predetermined corrective attribute; and performing image matching based upon the corrected numerical distribution.

A target image may be a biometric image such as an image of a fingerprint, an image of a palm, an image of finger veins and an iris image. The “attribute” is a combination of a characteristic biometric element (for example, a ridge, a furrow, a vein, etc.) that can be used for authentication and the feature of such an element that can be numerically represented (for example, the number of such elements, the length of the element, the angle that the element forms, the density of elements, etc.) For a corrective attribute, an attribute, which is subject to only a small variation even if an error occurs in image due to some factor in image capturing equipment, imaging environment or the like, is selected depending on the equipment used. This ensures that information on distribution of attributes used in matching is corrected such that adverse effects from an error are reduced. Distribution information from only one of the two images may be corrected with respect to the other. Alternatively, distribution information from both images may be subject to correction for an error with respect to a given reference.

The matching apparatus according to the third embodiment comprises: an imaging unit which captures a biometric image; a distribution obtaining unit which obtains a numerical distribution of a plurality of attributes from a captured image; a correction unit which corrects the numerical distribution of an attribute to be checked for matching, based upon the numerical distribution of a predetermined corrective attribute; and a matching unit which matches two images against each other based upon the corrected numerical distribution of the attribute to be checked for matching.

The matching apparatus according to the third embodiment may further comprise: a storage unit which stores the numerical distribution of the plurality of attributes in a reference image, wherein the correction unit corrects the numerical distribution of the attribute to be checked for matching occurring in an image to be authenticated, in such a way as to minimize a difference between the numerical distribution of the corrective attribute in the image to be authenticated as obtained in the distribution obtaining unit and the numerical distribution of the corrective attribute in the reference image as stored in the storage unit, and the matching unit matches the image to be authenticated against the reference image based upon the numerical distribution of the attribute to be checked for matching occurring in the image to be authenticated and upon the numerical distribution of the attribute to be checked for matching occurring in the reference image and stored in the storage unit.

Optional combinations of the aforementioned components, and implementations of the third embodiment in the form of methods, apparatuses, systems, computer programs and recording mediums may also be practiced as additional modes of the third embodiment.

### EXAMPLE 1

In a first example of practicing the third embodiment, a fingerprint image is divided in one direction. For each strip area produced by division, an average value representing vectors that characterize the directions of ridges in the area is calculated. Matching between fingerprints is performed based upon the distribution of the vectors in the direction of division. By dividing an image in the direction in which a user slides his or her finger in a sweep sensor fingerprint authentication apparatus, the image captured by a line sensor matches the strip area. Accordingly, accurate authentication is achieved using only a small amount of memory.

A problem is that, in building a whole image from images captured by a line sensor, an error may easily occur due to expansion or contraction in the direction in which the user slides his or her finger. This causes variation in the distribution of vectors used in matching, thereby producing a matching error. In this background, a corrective feature index that does not vary in its absolute value from one strip area to another even if an error due to expansion or contraction occurs may be obtained concurrently with the obtaining of a vector to be checked for matching. Before matching, the vector distribution is corrected by the amount of error due to expansion or contraction as determined by referring to the distribution of corrective feature indexes. The corrective feature index used in the first example of practicing the third embodiment is the number of ridges that exist in an strip area.

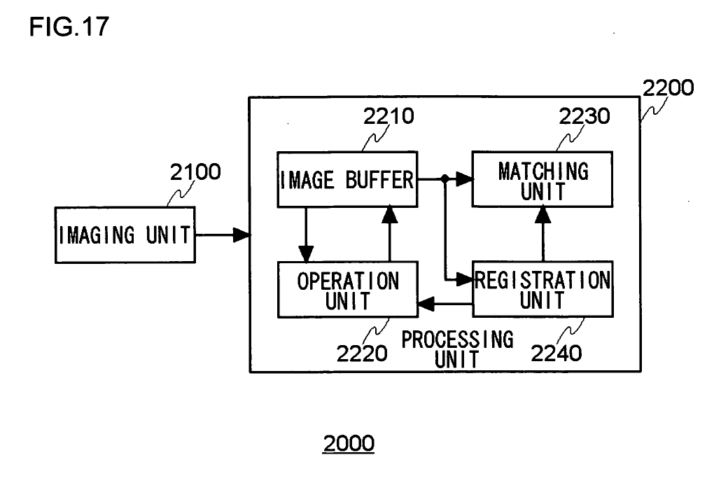

FIG. 17 is a functional block diagram of a matching apparatus according to the first example of practicing the third embodiment of the present invention. The blocks as shown may be implemented by hardware including components such as a processor, a RAM, etc. and devices such as a sensor. The blocks may also be implemented by software including a computer program. FIG. 10 depicts functional blocks implemented by cooperation of hardware and software. Therefore, it will be obvious to those skilled in the art that the functional blocks may be implemented by a variety of manners by a combination of hardware and software.

The matching apparatus 2000 is provided with an imaging unit 2100 and a processing unit 2200. The imaging unit 2100, which is implemented by a charge coupled device (CCD) or the like, captures an image of a user's finger and outputs resultant image data to the processing unit 200. For example, the user may hold his or her finger over a CCD-based line sensor built in a mobile appliance. A fingerprint image is captured by sliding the finger in a direction perpendicular to the line sensor.

The processing unit 2200 includes an image buffer 2210, an operation unit 2220, a matching unit 2230 and a registration unit 2240. The image buffer 2210 is a memory area used to temporarily store image data from the imaging unit 2100 or used as a work area of the operation unit 2220. The operation unit 2220 analyzes the image data in the image buffer 2210 and performs various operations described later. The matching unit 2230 compares data of an image to be authenticated stored in the image buffer 2210 with reference data of a reference image stored in the registration unit 2240 so as to determine whether the fingerprint images belong to the same person. The registration unit 2240 registers as reference data a result of analyzing the reference image of a fingerprint captured beforehand. When implemented in cell phones, the registration unit 2240 may register data for a single person in a majority of cases. In applications like entrance control at a gate or the like, data for multiple persons may usually be registered.

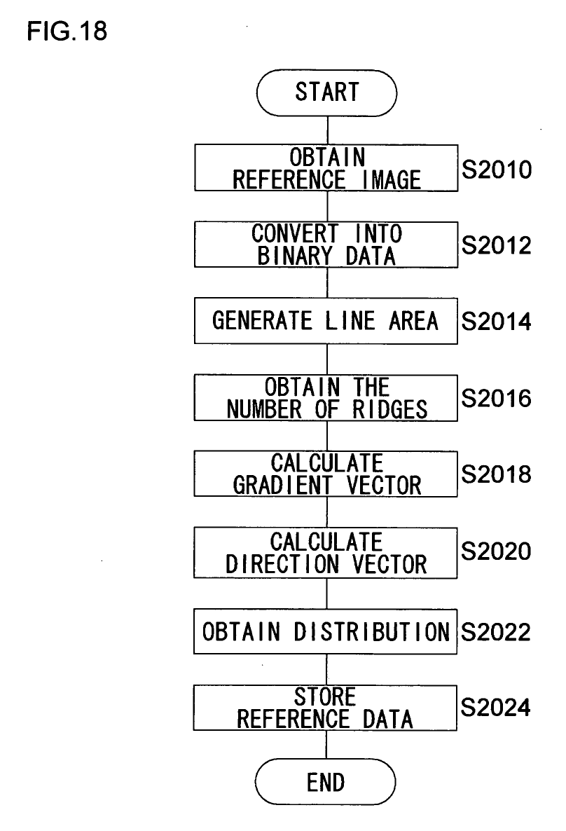

FIG. 18 is a flowchart showing a process for generating reference data for use in the matching apparatus 2000. The reference data as recorded comprises matching data and correction data. The matching data includes the distribution of average values representing vectors that characterize the directions of ridges, and the correction data comprises the distribution of the number of ridges.

The imaging unit 2100 captures an image of a finger of a user held over the imaging unit 2100 and converts the image into an electric signal for output to the processing unit 2200. The processing unit 2200 acquires the signal as reference image data and temporarily stores the data in the image buffer 2210 (S2010). A two-dimensional fingerprint image is built from a series of images captured by a line sensor included in the imaging unit 2100 according to an ordinary algorithm and is stored subsequently. The operation unit 2220 converts the image data into binary data (S2012). For example, a pixel having a brightness value that exceeds a predetermined threshold value is determined to be a white pixel, and a pixel having a brightness value that is below the threshold value is determined to be a black pixel. By representing white as 1 or 0 and black as 0 or 1, binary data is obtained.

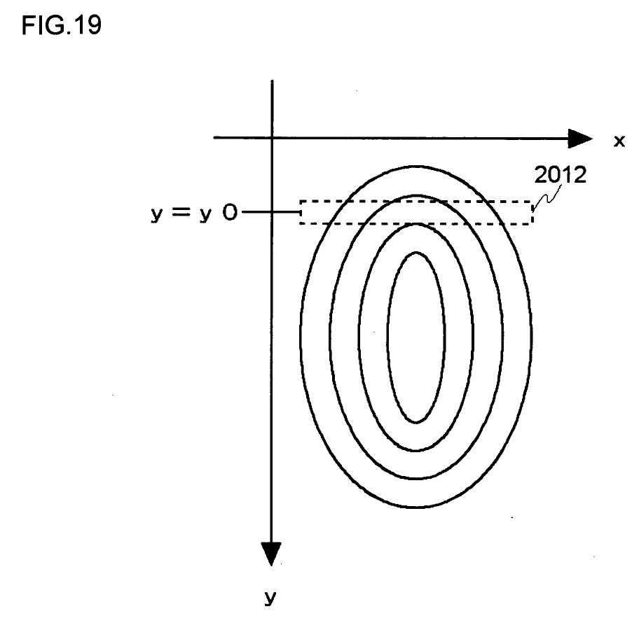

Subsequently, the operation unit 2220 divides binarized image data to produce multiple strip areas (S2014). FIG. 19 shows a fingerprint image thus built. Referring to FIG. 19, the y axis of the coordinate system indicates a direction in which a user slides his or her finger. By dividing the image in the y direction, strip areas 2012 longitudinally extending in the x axis direction and latitudinally extending in the y axis direction are generated over the entirety of the fingerprint image. The width in the latidudinal direction may be set to, for example, 3 pixels.

Referring back to FIG. 18, the operation unit 2220 obtains the number of ridges in each strip area produced in S2014 (S2016). For example, the number of ridges may be obtained by scanning the center line of the strip area in the x axis direction and detecting the number of times that the pixel value changes. In S2016, the density of ridges may be obtained instead of the number of ridges. In this case, the density is obtained by accumulating pixel values while scanning the center line of the strip area in the x axis direction and by dividing an accumulated total by the number of pixels in the fingerprint area that includes the center line.

Subsequently, the operation unit 2220 sequentially calculates in the x axis direction gradient vectors indicating gradients between pixel values that represent ridges in each strip area (S2018). In calculating gradient vectors, a method for calculating density gradient generally used in edge detection in a multi-valued image may be employed. Such a method is described, for example, in “Computer Image Processing, Hideyuki Tamura, Ohmsha, Ltd., pp. 182-191.”

A brief description will now be given of the method. For calculation of gradient in a digital image, it is necessary to induce first-order partial differentiation in the x direction and in the y direction.
Δₓf(i,j)≡{f(i+1,j)−f(i−1,j)}/2 (10)
Δ_{y}f(i,j)≡{f(i,j+1)−f(i,j−1)}/2 (11)

By using a differential operator, a derivative at a pixel at (i, j) in a digital image is defined as a linear combination of pixel values of pixels in a 3×3 array around the pixel at (i, j). More specifically, the derivative is defined as a linear combination of f(i−1, j−1), f(i, j−1), f(i+1, j−1), f(i−1, j), f(i, j), f(i+1, j), f(i−1, j+1), f(i, j+1), f(i+1, j+1). This means that calculation for determining derivatives in an image is achieved by using spatial filtering that uses a 3×3 weighting matrix. Various differential operators are represented by 3×3 weighting matrixes. In the following description, it will be assumed that the pixel at (i, j) and the surrounding pixels in the 3×3 array are denoted below. A differential operator is described as a weighting matrix applied to the pixels.

$$\begin{matrix}f ( i - 1 , j - 1 ) & f ( i , j - 1 ) & f ( i + 1 , j - 1 ) \\ f ( i - 1 , j ) & f ( i , j ) & f ( i + 1 , j ) \\ f ( i - 1 , j + 1 ) & f ( i , j + 1 ) & f ( i + 1 , j + 1 )\end{matrix} \qquad ( 12 )$$

For example, the first-order differential operators in the x and y directions defined by expressions (10) and (11) are represented as follows.

$$\begin{matrix}0 & 0 & 0 \\ - 1 / 2 & 0 & 1 / 2 \\ 0 & 0 & 0\end{matrix} \\ and \\ \begin{matrix}0 & - 1 / 2 & 0 \\ 0 & 0 & 0 \\ 0 & 1 / 2 & 0\end{matrix} \qquad ( 13 )$$

That is, products between pixel values and corresponding element values in a matrix is obtained in a 3×3 rectangular area represented by expressions 12 and 13. Calculation of a sum of the products yields the same result as given on the right-hand side of expressions 10 and 11.

As a result of spatial filtering using a weighting matrix of expression (4) and calculating partial derivatives in the x and y directions as defined in expressions (10) and (12), the magnitude and direction of gradients are determined as given below.
|∇f(i,j)|=√{Δₓf(i,j)²+Δ_{y}f(i,j)^{2}} (14)
θ=tan⁻¹{Δ_{y}f(i,j)/Δₓf(i,j)} (15)

A Roberts operator, a Brewitt operator or a Sobel operator may be used as a differential operator. In this way, the operator is calculated in a simplified fashion and noise is effectively removed as well.

The operation unit 2220 obtains the x component and the y component of a direction vector representing a ridge in a strip area by obtaining a vector derived by doubling the angle (the orientation of the direction determined by expression (15) with respect to the coordinate axis, i.e. the angle of a gradient vector) (S2020). Hereinafter, such a vector will be referred to as an auxiliary vector. In the first example, direction vectors representing ridges are calculated by using gradient vectors. At the two boundaries of a black area indicating a ridge, the directions of gradient vectors are opposite to each other. If no countermeasures are introduced, problems may occur such as cancellation of directional components upon calculation of a sum for determining an average value. In this case, complex compensation measures are necessary to address the fact that 180° and 0° are equivalent. Thus, by deriving auxiliary vectors oriented in the same direction at the borders of a ridge as described above, subsequent calculation is simplified. For example, in the case of a ridge having borders represented by direction vectors with angles of 45° and 225°, the angles of auxiliary vectors are 90° and 450°, respectively, which indicate a unique direction.

The direction vectors are used for comparison between images. Given that a common rule is established, a gradient vector representing the unique direction of a ridge may be calculated by strictly referring to an auxiliary vector, whereupon a vector perpendicular to the gradient vector may be calculated. Alternatively, the values of an auxiliary vector may be employed unmodified to determine a direction vector (hereinafter, vectors thus obtained will be generically referred to as direction vectors). In either case, the auxiliary vector thus determined may contain some error because two values respectively occur at the two boundaries of an area representing a ridge. Accordingly, an average value is calculated for an individual ridge.

Subsequently, the operation unit 2220 calculates a component-by-component total of the direction vectors representing all ridges in each strip area and divide the sum by the number of ridges. In this way, the average values of the direction vectors are obtained. The distribution of the values in the y axis direction is then obtained (S2022). The operation unit 2220 stores the distribution in the registration unit 2240 as reference data (S2024). In this process, the number of ridges in each strip area obtained in S2016 is also stored as part of the distribution in the y axis. The operation unit 2220 may apply a smoothing process described later to the reference data before storing the data.

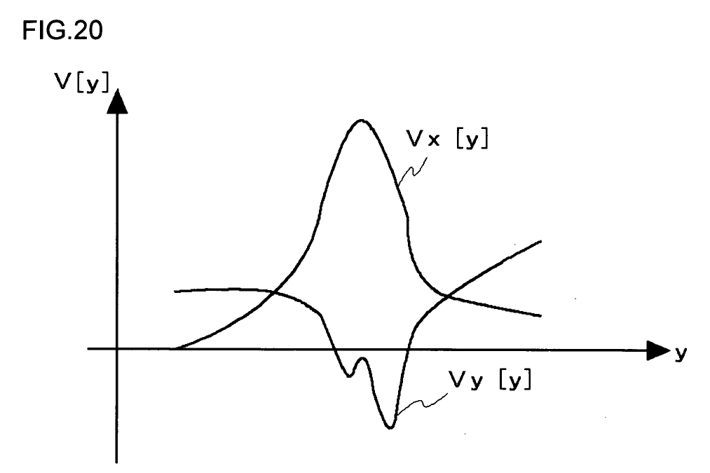

FIG. 20 shows an example of how the direction vectors of ridges stored in S2024 are distributed. Referring to FIG. 20, the horizontal axis represents the y axis of FIG. 19 and the vertical axis represents an average value V[y] of the direction vectors in each strip area. As mentioned above, average values representing vectors are obtained component by component. Therefore, two types of distribution, i.e., Vy[x] representing the distribution of x components and Vy[y] representing the distribution of y components, are obtained.

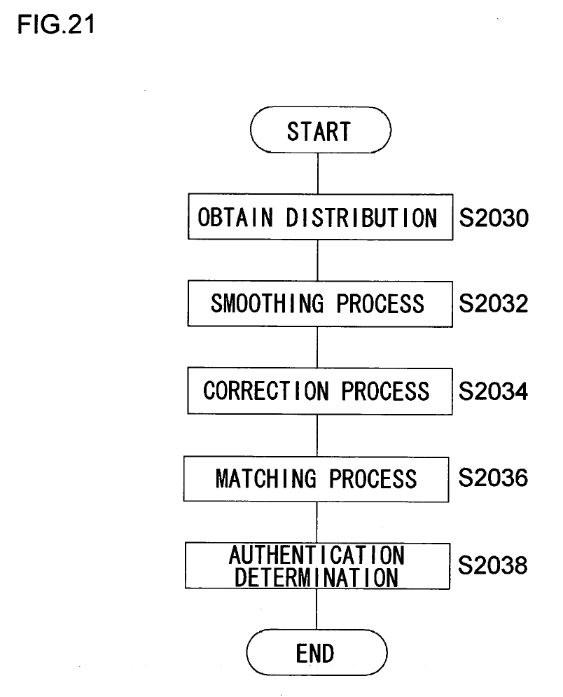

FIG. 21 is a flowchart for an authentication process in the matching apparatus 2000. Similarly to the case of a reference image, the imaging unit 2100 captures an image of a finger that the user requesting authentication holds over the imaging unit 2100 and converts the captured image into an electrical signal for output to the processing unit 2200. The processing unit 2200 obtains the signal as image data, builds a fingerprint image and temporarily stores the same in the image buffer 2210 as an image to be authenticated. Thereupon, the processing unit 2200 performs the same processes as performed in S2012-S2022 of FIG. 18 so as to obtain, as data to be authenticated, the distribution of direction vectors representing ridges and the distribution of the number of ridges (S2030).

Subsequently, the operation unit 2220 subjects each distribution to a smoothing process (S2032). For example, two successive numerical values are averaged. The level of smoothing may differ depending on applications in which the system is used. Optimal values may be determined experimentally.

Subsequently, the operation unit 2220 calculates required correction by comparing the distribution of the number of ridges in a reference image stored in the registration unit 2240 and the distribution of the number of ridges in an image to be authenticated, so as to correct the distribution of direction vectors in the image to be authenticated (S2034) accordingly. The above step will be described in detail later.

Subsequently, the matching unit 2230 matches the distribution of direction vectors representing ridges in a reference image stored in the registration unit 2240 against the corrected distribution of direction vectors in the image to be authenticated (S2036). For reduction of computational volume, interest points in two distributions are detected. The distribution occurring at the interest points and the neighborhood thereof is checked for matching. An interest point may be a point where one of the components is at maximum, a point where one of the components is 0, a point where a derivative is 0 or a point with highest gradient.

Matching may be performed by detecting, component by component and at each point on the y axis, a difference between a reference image and an image to be authenticated in respect of the distribution as numerically represented. For example, the following expression (16) may be used to calculate the energy E of matching.
E=Σ√{ΔVx[y]²+ΔVy[y]^{2}} (16)

where ΔVx[y] and ΔVy[y] denote a difference in x components and a difference in y components, respectively. The matching energy E is a product of the y value by the magnitude of an error vector. The higher the matching energy E, the larger the error between distributions. The smaller the matching energy, the closer the distributions are. The relative positions of the distribution patterns are adjusted by shifting the patterns in such a way as to minimize the matching energy E. Other pattern matching methods may also be employed. For example, a sum of the absolute values of the errors ΔVx[y] in x components and a sum of the absolute values of the errors ΔVy[y] in y components may be obtained. Alternatively, a matching method that yields high precision may be determined experimentally and used.

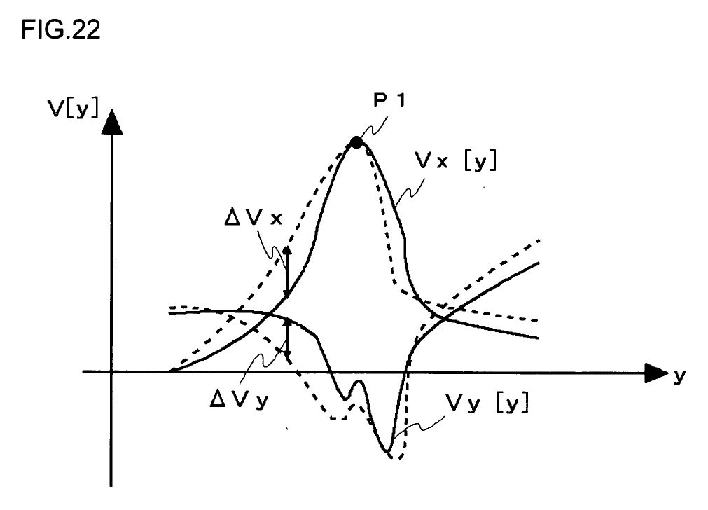

FIG. 22 is a graph showing how the above-described pattern matching is applied to distributions in two images. In this graph, the distributions of x and y components of the direction vectors in a reference image are indicated by solid lines and those of an image to be authenticated are indicated by broken lines. In the illustrated example, the maximum values in the x component distributions are detected. Pattern matching is performed when the relative positions of the graphs are such that the maximum values p1 are plotted at the same position and also when one of the graphs (i.e. the pattern of the reference image or the pattern of the image to be authenticated) is shifted by a predetermined infinitesimal distance in both directions. The relative positions that produce the minimum matching energy E are determined as positions where the graphs should be superimposed.

Referring back to FIG. 21, the matching unit 2230 performs authentication by comparing the minimum value of the matching energy E calculated with a preset threshold value for determination of authentication (S2038). That is, if the minimum value of the matching energy E is less than the threshold value, it is determined that the reference image matches the image to be authenticated, whereupon the user with the fingerprint image is authenticated. Conversely, if the matching energy E is equal to or greater than the threshold value, the user is not authenticated. In case a plurality of sets of reference data are registered, pattern matching is performed between the data to be authenticated and each of the reference data set.

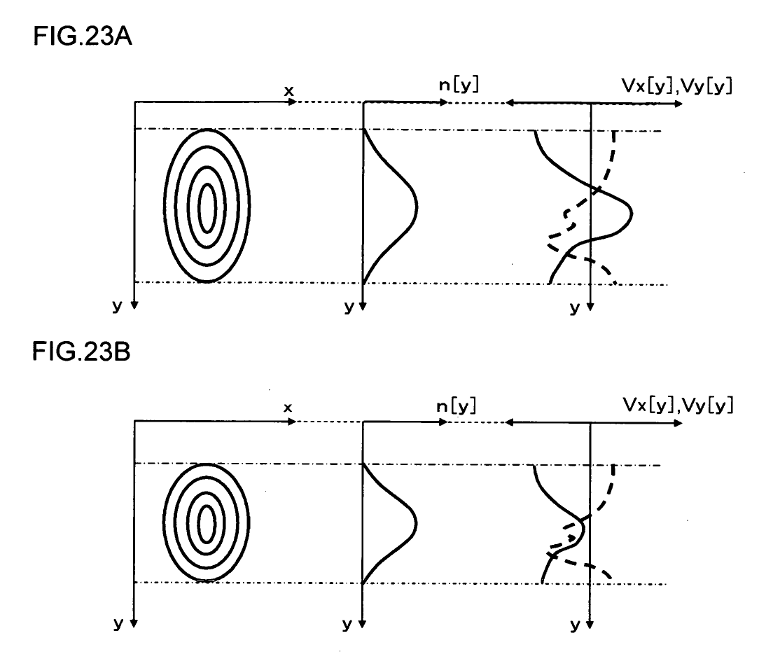

FIGS. 23A and 23B show how the distribution of direction vectors representing ridges is corrected in S2034 of FIG. 21 by the distribution of the number of ridges. Depicted leftmost in FIG. 23A is an image to be authenticated, a fingerprint image built from images captured by a line sensor; and depicted leftmost in FIG. 23B is a reference image, also a fingerprint image built from images captured by a line sensor. The graph in the middle of FIGS. 23A and 23B depicts the distribution n[y] of the number of ridges in the image, and the graph on the right depicts the distribution Vx[y], Vy[y] of direction vectors representing ridges. It will be noted that the graph for the image to be authenticated is expanded in the y axis direction as compared to the reference image. The distributions are expanded in association with the expansion of an area including the fingerprint image. The values representing the distribution are also affected due to the expansion in the y direction occurring when determining gradient vectors. If the distributions Vx[y] and Vy[y] of the direction vectors are matched against the reference data without being corrected, the resultant matching energy E is not minimized at any relative positions of the distribution patterns superimposed on each other. This may result in an authentic fingerprint not being authenticated.

In contrast, the distribution of the number of ridges remains unaffected in its value by the expansion of an image. This allows calculation of required correction (the degree of expansion of the image to be authenticated), by comparing the distributions of the number of ridges in the image to be authenticated with that of the reference image. For example, by performing the above-described pattern matching between the reference data and the data to be authenticated, as the distribution pattern of the number of ridges in the image to be authenticated is expanded or contracted, a magnification factor that minimizes the matching energy E is obtained. The distribution pattern of the direction vectors is expanded or contracted by the magnification factor thus obtained and the values representing the distribution are corrected. A coefficient for correction to be multiplied by the values representing the distribution may be retrieved by referring to a table that lists magnification factors in relation to coefficients for correction.

Thus, according to the first example of practicing the third embodiment, linear distribution of average values of direction vectors is used for matching. Consequently, the computational load is lowered and the speed of authentication process is increased. Since the reference data represents linear distribution, memory resources are saved. Since a strip area produced by division corresponds to an image captured by a line sensor, accuracy of resultant distribution is insured. The above-described method enables correction of error-prone expansion or contraction of a fingerprint image in the direction in which the user slides his or her finger, by obtaining a corrective feature index that does not vary in its absolute value with the expansion or contraction as well as obtaining a feature index to be checked for matching. Thus, highly precise matching is achieved. Another point is that, by taking an average of feature indexes in a strip area, adverse effects from blurring of an image in the sliding direction and the direction perpendicular to that are properly controlled. This will increase precision in battery-driven mobile equipment in which power saving is desired and the mounting area is limited.

### EXAMPLE 2

In the first example of practicing the third embodiment, the number of ridges in a strip area is obtained as a corrective feature index and the average value of direction vectors representing ridges is obtained as a feature index for matching. In the second example of practicing the third embodiment, ridges are categorized according to an angle formed with respect to a reference direction. The number of ridges belonging to the respective categories is used as a feature index.

The second example of practicing the third embodiment is also implemented by the matching apparatus 2000 shown in FIG. 17 illustrating the first example. The following description primarily concerns a difference from the first example.

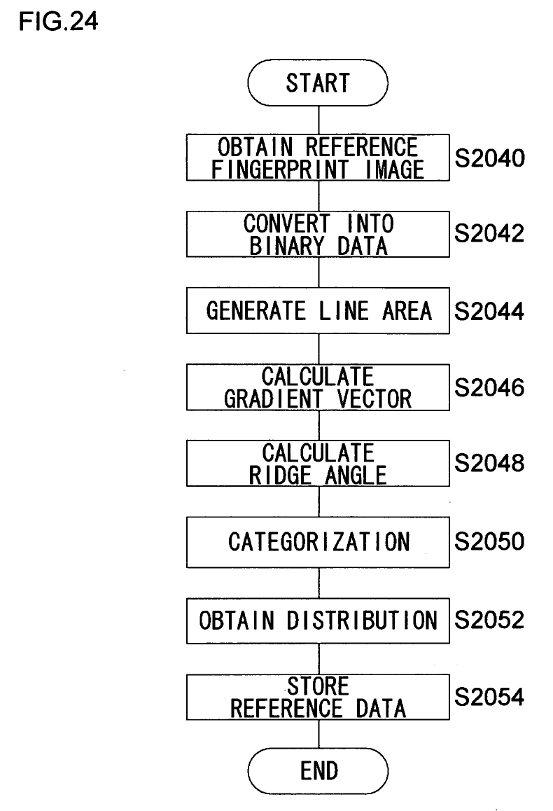

FIG. 24 is a flowchart showing a process for generating reference data according to the second example. Similarly to the first example, a fingerprint image is built from image data input to the processing unit 2200 and temporarily stored in the image buffer 2210 as a reference image (S2040). The operation unit 2220 converts the image into binary data (S2042) and produces multiple strip areas by dividing the image in the direction in which a user slides his or her finger, i.e., in the y axis direction (S2044). The width of the strip area may be set such that neighboring areas overlap. Subsequently, using the same method as described in the first example, the operation unit 2220 sequentially calculates gradient vectors between pixel values representing ridges in each strip area in a direction perpendicular to the direction in which the user slides his or her finger, i.e., the x axis direction (S2046).

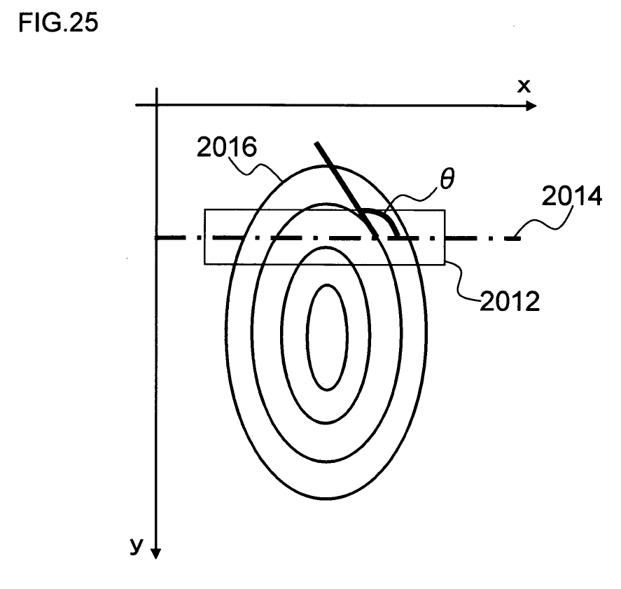

The operation unit 2220 obtains angles that uniquely define the directions of ridges by determining auxiliary vectors and calculate ridge by ridge the angle formed by the ridge with respect to the x axis (S2048). Subsequent calculation involves comparison between angles. Therefore, similarly to the first example, the angle formed by an auxiliary vector may be used unmodified as a value indirectly indicating the angle of a ridge. In the following description, the angle θ as shown in FIG. 25 is defined, assuming that the exact angle of a ridge is obtained, where 0°≦θ<180°. As is already described, a strip area 2012 may have a width of several pixels extending in the y axis direction that overlaps another strip area. As shown in FIG. 25, the angle of a ridge is defined as an angle θ formed by a center line 2014 of the strip area 2012, for which gradient vectors are determined, and by a ridge 2016 that appears in a pixel including the center line 2014 and in neighboring pixels.

Referring back to FIG. 24, the operation unit 2220 categorizes the ridges in accordance with the angle they form, each category being defined for a certain angle range, and obtains the number of ridges belong to the categories for all strip areas (S2050). In this step, the ridges are categorized according to a first categorization to produce corrective feature indexes and categorized according to a second categorization to produce feature indexes for matching. Table 1 lists examples of angle ranges of ridges that characterize the first category and the second category.

TABLE 1

| FIRST | SECOND | |
|---|---|---|
| CATEGORIZATION | CATEGORIZATION | ANGLE RANGE |
| 1-1 | 2-1 | 0° ≦ θ < 45° |
| | 2-2 | 45° ≦ θ < 90° |
| 1-2 | 2-3 | 90° ≦ θ < 135° |
| | 2-4 | 135° ≦ θ < 180° |

As shown in Table 1, according to the first categorization, the ridges are categorized into groups 1-1 and 1-2, wherein the angle ranges are 0°≦θ<90° and 90°≦θ<180°. In other words, the ridges are categorized according to whether the ridge is upward-sloping or downward-sloping. Even if a fingerprint image built from images input via the imaging unit 2100 is expanded or contracted in the y axis direction, the numbers of upward-sloping ridges and downward-sloping ridges in each strip area remain unchanged. Accordingly, the number of ridges belonging to the categories as a result of the first categorization can be used as a corrective feature index. In the second categorization, the ridges are grouped into four categories 2-1 through 2-4, wherein the angle ranges are 0≦θ<45°, 45°≦θ<90°, 90°≦θ<135° and 135°≦θ<180°. In the second example of practicing the third embodiment, the number of ridges belonging to the categories as a result of the second categorization is used as a feature index for matching.

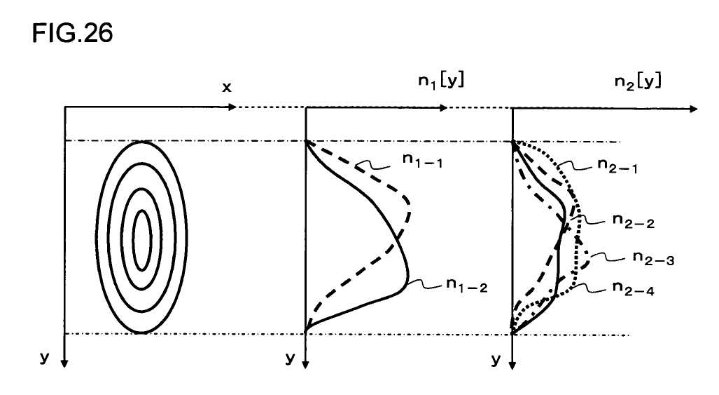

The operation unit 2220 obtains the distributions of the number of ridges belonging to the categories as a result of the first and second categorizations in the y axis direction (S2052) and stores the distributions in the registration unit 2240 as reference data (S2054). Hereinafter, these distributions will be referred to as a first category distribution and a second category distribution. FIG. 26 schematically shows how the reference fingerprint image, the first category distribution and the second category distribution correspond to each other. Referring to FIG. 26, the first categorization results in the distributions n₁₋₁ [y] and n₁₋₂ [y] of the number of ridges belonging to the category 1-1 and the number of ridges belonging to the category 1-2, respectively, along the y axis in the fingerprint image shown leftmost. The second categorization results in the distributions n2-1[y], n2-2[y], n2-3[y] and n2-4[y] of the number of ridges belonging to the category 2-1, the number of ridges belonging to the category 2-2, the number of ridges belonging to the category 2-3 and the number of ridges belonging to the category 2-4, respectively. Numerical values representing the distribution n[y] are plotted against respective y values representing the center lines of strip areas. Therefore, if more precise matching is desired using more detailed distribution, strip areas may successively be produced such that the position of the center line is shifted only slightly in each step, irrespective of the width of the strip area. Similarly to the first example of practicing the third embodiment, the distribution subject to a smoothing process may be stored.

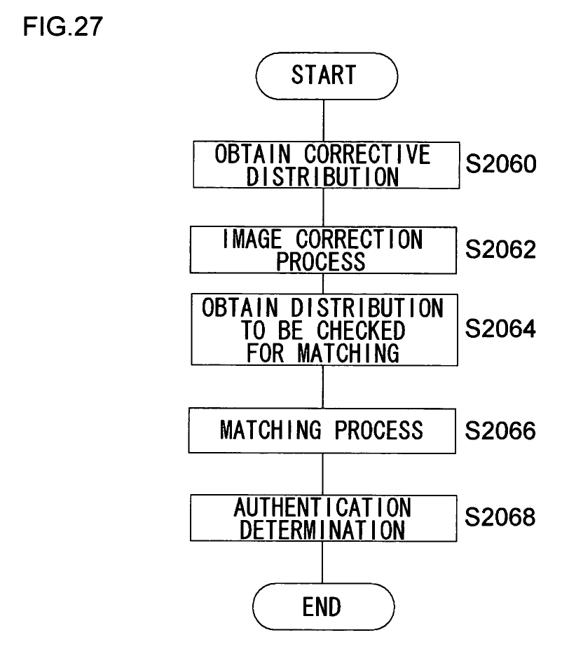

FIG. 27 is a flowchart for an authentication process in the matching apparatus 2000. Similarly to S2040-S2048 of FIG. 24, a fingerprint image is built from captured images and temporarily stored in the image buffer 2210 and is then subject to binarization and a process of producing strip areas. The angles of ridges that exist in each strip area are calculated so that the ridges are categorized. In the matching process, only the first categorization is performed so that the first category distribution is obtained first for the purpose of correction.

Thus, in the second example of practicing the third embodiment, the operation unit 2220 calculates required correction by comparing the first category distribution in the reference image stored in the registration unit 2240 with the first category distribution obtained in S2060, so as to correct the fingerprint image stored in the image buffer 2210 (S2062) accordingly. Correction proceeds similarly to the first example. Namely, a magnification factor for correction is determined based upon the distribution of the numbers of ridges. A fingerprint image expanded or contracted by the factor thus determined and is stored in the image buffer 2210. The operation unit 2220 produces strip areas from a fingerprint image as amended and obtains the second categorization distribution using the same method as described above in connection with the reference image (S2064). Since the second category distribution is obtained from the corrected fingerprint image, correction is applied to the second category distribution as in the case of the first example of practicing the third embodiment.

In S2066, the matching unit 2230 matches the second category distribution in the reference image stored in the registration unit 2240 against the corrected second category distribution in the image to be authenticated. Matching performed is similar to that performed in the first example. A difference is that the matching energy E is calculated as a root of sum of squares of errors occurring between the four-category distributions 2-1 through 2-4, instead of using the expression (16) employed in the first example. As in the first example, authentication determination is made by referring to the minimum value of the matching energy E thus calculated (S2068).

Similarly to the first example of practicing the third embodiment, the second example ensures that matching error, which occurs due to error-prone expansion or contraction of an image in a direction in which a user slides his or her finger in a sweep sensor authentication apparatus using a line sensor, is reduced by applying correction by a corrective feature index which does not vary in its absolute value with expansion or contraction. As a result, highly precise matching is achieved. Further, by grouping the ridges into four categories according to the angle so that matching is performed using linear distribution of the number of ridges belonging to the categories, the computational load is reduced and the speed of authentication is increased. Since the reference data represents linear distribution, memory resources are saved. The second example does not require a high-speed CPU or a large-capacity memory and so is implemented in inexpensive LSIs. The cost of an authentication apparatus or mobile equipment incorporating the same is reduced accordingly.

### EXAMPLE 3

In the second example, the ridges are categorized according to the angle they form. The number of ridges belonging to the categories is obtained as a corrective feature index and as a feature index for matching. In the third example of practicing the third embodiment, the ridges are categorized according to the length of the center line of a strip area in an image area representing a ridge (hereinafter, such a length will be referred to as a ridge area length). The number of ridges belonging to the categories is used as a feature index for matching.

The third example is also embodied by the matching apparatus 2000 shown in FIG. 17 in the first example. The following description primarily concerns a difference from the first and second examples.

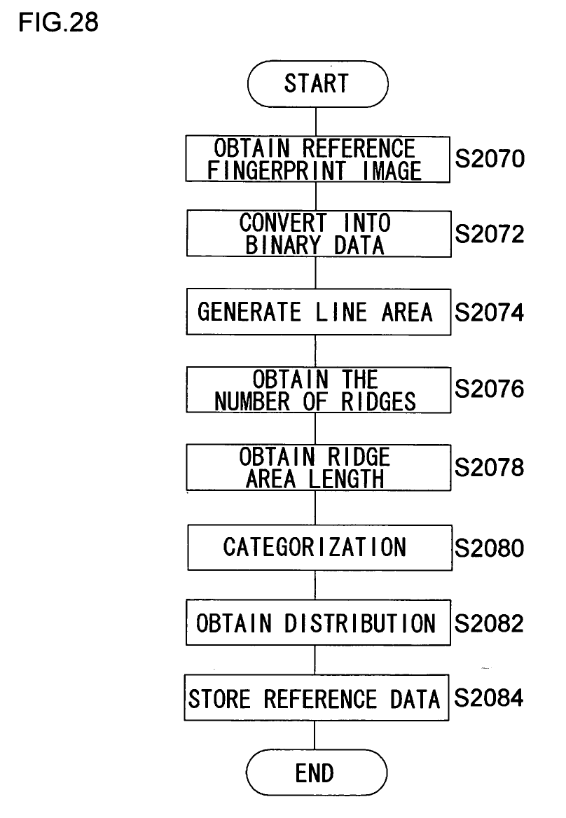

FIG. 28 is a flowchart for a process of producing reference data in the third example of practicing the third embodiment. As in the first and second examples, a fingerprint image is built from image data input to the processing unit 2200 and is temporarily stored in the image buffer 2210 (S2070). The operation unit 2200 converts the image data into binary data (S2072) and produces multiple strip areas by dividing the image in the direction in which a user slides his or her finger, i.e., in the y axis direction (S2074). Unlike the first and second examples, gradient vectors representing ridges are not obtained in the third example. Only the number of ridges crossing the center line of a strip area and the length of the center line in the ridge area are used. Therefore, the step of S2074 merely involves setting the position of the center line. In an alternative approach, when it is desired that the ridge count and the length values be obtained above and below the center line and average values be obtained to represent the ridge count and the length values occurring in the center line, a strip area of a desired width may be set up.

As in the first example, the operation unit 2220 subsequently obtains the number of ridges in each strip area (S2076). As in the first example, the number of ridges is used as a corrective feature index.

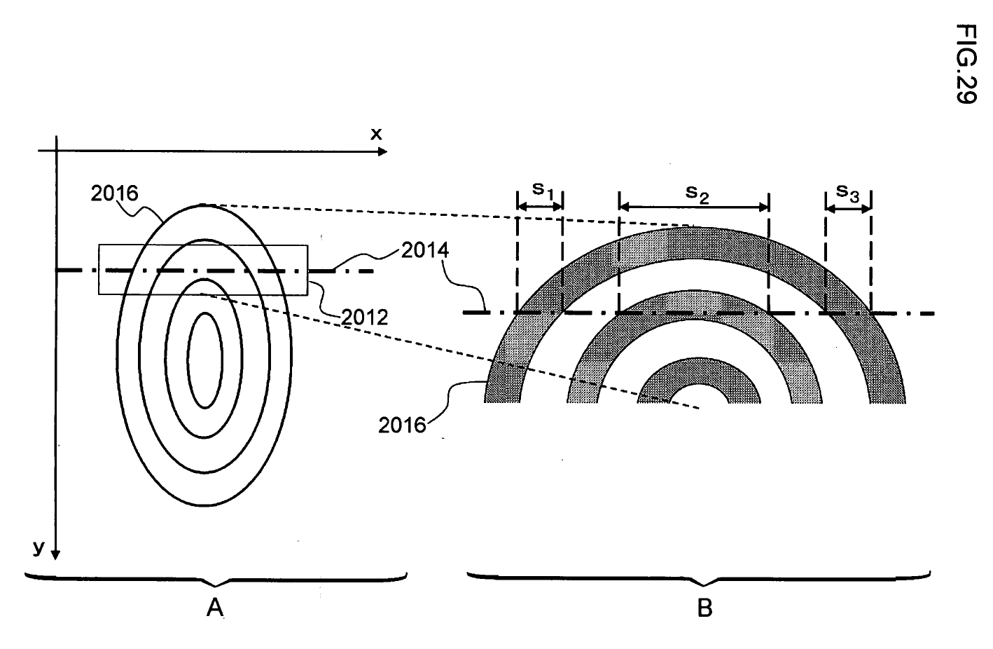

The operation unit 2220 obtains the ridge area lengths of ridges located in each strip area (S2078). FIG. 29 is a schematic diagram illustrating a ridge area lengths obtained in S2078. Section A of FIG. 29 is an overall fingerprint image, showing how the center line 2014 of the strip area 2012 intersects the ridge 2016. Section B of FIG. 29 gives an enlarged view of the intersection. Since the ridge 2016 comprises a stretch of area formed by pixels with pixel values of black, the intersection between the center line 2014 and the ridge 2016 occurs over a certain length. This length is used as a ridge area length for the purpose of matching. In section B, the ridge area lengths of the ridges 2016 are denoted by S1, S2 and S3. The ridge area length is obtained by, for example, scanning the center line 2014 in the x axis direction and counting the number of pixels occurring between a switch from white to black and a switch from black to white.

Referring back to FIG. 28, the operation unit 2220 categorizes the ridges according to the ridge area length, each category being defined for a certain length range. The operation unit 2220 obtains the number of ridges belonging to the categories for all strip areas (S2080). Table 2 lists examples of ranges of ridge area length that characterize the categories.

TABLE 2

| CATEGORY | RANGE OF RIDGE AREA LENGTH |
|---|---|
| 3-1 | 1 ≦ s < 10 |
| 3-2 | 10 ≦ s < 30 |
| 3-3 | 30 ≦ s |

In the categorization according to Table 2, the ridges are grouped into three categories 3-1 through 3-3. The ranges of ridge area length are 1≦s<10, 10≦s<30 and 30≦s. The width of one pixel is used as a unit of length.

The operation unit 2220 derives a distribution in the y axis direction of the number of ridges belonging to the categories obtained for all strip areas or for all center lines (S2082). The registration unit 2240 stores the distribution as reference data (S2084). Similarly to the second embodiment, numerical values included in the distribution are obtained for each y value representing the center line of the strip area. Therefore, for the purpose of obtaining detailed distribution, it is ensured in S2074 that the variation in the position of the center line occurs only slightly in each step. The reference data may be subject to a smoothing process. Smoothing may not be necessary if the ridge area length is obtained for lines of pixels other than the center line in a strip area of a certain width and if the length value occurring at the center line is defined as an average of the length values.

The authentication process according to the third embodiment proceeds as shown in FIG. 27 of the second embodiment. That is, a fingerprint image is built from captured images and temporarily stored in the image buffer 2210 for binarization and strip area generation. The number of ridges located in each strip area is obtained so as to produce a distribution for correction (S2060).

The operation unit 2220 calculates required correction by comparing the distribution of the number of ridges in the reference image stored in the registration unit 2240 and the distribution of the number of ridges obtained in S2060 so as to correct the fingerprint image stored in the image buffer 2210 accordingly (S2062). The operation unit 2220 produces strip areas from the corrected fingerprint image and obtains the ridge area length distribution according to the same method as described in connection with the reference image (S2064).

Subsequently, similarly to the first and second examples, the matching unit 2230 matches the ridge area length distribution constituting the reference data with the ridge area length distribution obtained from the corrected fingerprint image (S2066). The matching energy E is calculated as a root of sum of squares of errors occurring between the three categories of distribution 3-1 through 3-3, instead of using the expression (16). Authentication determination is made by referring to the minimum value of the matching energy E thus calculated (S2068).

Similarly to the first and second examples of practicing the third embodiment, the third example ensures that matching error, which occurs due to error-prone expansion or contraction of an image in a direction in which a user slides his or her finger in a sweep sensor authentication apparatus using a line sensor, is reduced by applying correction by a corrective feature index which does not vary in its absolute value with expansion or contraction. As a result, highly precise matching is achieved. Further, by grouping the ridge area lengths into three categories so that matching is performed using linear distribution of the number of ridges belonging to the categories, the computational load is reduced and the speed of authentication is increased. Since the reference data represents linear distribution, memory resources are saved. The second example does not require a high-speed CPU or a large-capacity memory and so is implemented in inexpensive LSIs. The cost of an authentication apparatus or mobile equipment incorporating the same is reduced. Since gradient vectors indicating gradients between pixel values are not calculated, the third example reduces the computational load more successfully and have more merit for high speed and low cost than the first and second examples.

Described above are several examples of practicing the third embodiment. The examples described are illustrative in nature and it will be obvious to those skilled in the art that various variations in constituting elements etc. are possible within the scope of the present invention.

In the examples described above, the corrective feature index is used to correct the feature index used for matching between a reference image and an image to be authenticated. For improvement in accuracy of reference data, reference data may be prepared by correcting, by the distribution of corrective feature indexes, multiple distributions of feature indexes checked for matching and derived from reference images captured at different occasions, and by averaging the corrected distributions. In this way, it is ensured that an error that occurred in building the image is included in the reference data only to a minimum degree. If a reference distribution of corrective feature indexes is available beforehand (for example, in a case where an ideal form of distribution of corrective feature indexes is theoretically determined), the reference distribution may be registered in the registration unit 2240. Required correction may be calculated based upon the reference distribution so that the distribution of feature indexes to be checked for matching may be corrected accordingly. In this way, an error that occurred in building the image is practically removed so that high-precision matching is possible.

In the described examples, it is assumed that correction addresses expansion or contraction of a fingerprint image in the y axis direction, the direction in which a user slides his or her finger. Data correction in the x axis direction is also possible by using the distribution of feature index that does not vary in its absolute value with expansion or contraction in the x axis direction. By using the distribution of feature index that does not vary in its absolute value with parallel translation, not only expansion or contraction but also twist can be corrected. By combining correction in the x axis direction and correction in the y axis correction, data correction in all directions is achieved. This reduces an error included in the feature index to be checked for matching so that more precise matching is achieved.

It will also be appreciated that, by replacing feature indexes such as the angle of a ridge, the number of ridges and the length of a ridge area by the angle of a vein, the number of veins and the length of a vein area, the inventive authentication may be applied to vein authentication. The inventive authentication also achieves high precision in other types of biometric authentication where the distribution of a given feature index is used for matching, by reducing an error that is likely to be included due to a factor dependent on an imaging system, using a feature index that is not affected by the error.

Categorization of feature indexes and the use of the distribution of the feature indexes for matching, which were described in the second and third examples of practicing the third embodiment, may be combined with another matching method. Matching based upon the distribution of categorized feature indexes may be used as a pre-processing step in the matching method with which it is combined. Matching based upon categorized feature indexes requires relatively low computational load. Therefore, by performing detailed matching only when it is determined that a reference image and an image to be authenticated match as a result of categorization-based matching, computation load is suppressed while maintaining precision. The method combined with the categorization-based method may be an ordinary matching method. The described process for correction may alone be combined with a different matching method. Whatever matching method may be used, matching precision is improved by performing inventive correction beforehand. If it is expected that an error due to expansion or contraction is not likely to occur, the process for correction may be omitted as the case may be.

In the second and third examples, a description was given of grouping into two and four categories, respectively. The number of categories may be modified as required, allowing for requirements for precision and computational load. The number of strip areas and the width thereof may also be subject to adjustment. An optimal number may be determined on an experimental basis. In this way, a low-cost, high-precision authentication apparatus adapted to environment in which it is in use is achieved.

The third embodiment encompasses methods and apparatuses as defined in 1 through 11 below.

1. A matching method comprising: obtaining a numerical distribution of a plurality of attributes in a biometric image; correcting the numerical distribution of one of the plurality of attributes by the numerical distribution of a predetermined corrective attribute; and performing image matching based upon the corrected numerical distribution.

2. The matching method according to 1, wherein the obtaining of the numerical distribution includes generating a plurality of sub-areas by dividing the biometric image and includes calculating numerical values of the plurality of attributes for each sub-area, and wherein the numerical distribution of the attributes is obtained by associating the positions of the sub-areas with the numerical values of the attributes.

3. The matching method according to 2, wherein the calculating includes categorizing biometric features according to the attributes they have and obtaining the frequency of each category for each sub-area, and wherein the matching includes matching two images against each other based upon the distribution of frequencies of the categories.

4. A matching apparatus comprising: an imaging unit which captures a biometric image; a distribution obtaining unit which obtains a numerical distribution of a plurality of attributes from a captured image; a correction unit which corrects the numerical distribution of an attribute to be checked for matching, based upon the numerical distribution of a predetermined corrective attribute; and a matching unit which matches two images against each other based upon the corrected numerical distribution of the attribute to be checked for matching.

5. The matching apparatus according to 4, further comprising: a storage unit which stores the numerical distribution of the plurality of attributes in a reference image, wherein the correction unit corrects the numerical distribution of the attribute to be checked for matching occurring in an image to be authenticated, in such a way as to minimize a difference between the numerical distribution of the corrective attribute in the image to be authenticated as obtained in the distribution obtaining unit and the numerical distribution of the corrective attribute in the reference image as stored in the storage unit, and the matching unit matches the image to be authenticated against the reference image based upon the numerical distribution of the attribute to be checked for matching occurring in the image to be authenticated and upon the numerical distribution of the attribute to be checked for matching occurring in the reference image and stored in the storage unit.

6. The matching apparatus according to 4, further comprising a storage unit which stores a reference distribution of the corrective attribute, the correction unit corrects the numerical distribution of the attribute to be checked for matching in such a way as to minimize a difference between the numerical distribution of the corrective attribute obtained in the distribution obtaining unit and the reference distribution of the corrective attribute, and the matching unit matches two images against each other based upon the corrected numerical distribution of the attribute to be checked for matching in the two images.

7. The matching apparatus according to any one of 4 through 6, wherein the biometric image is a fingerprint image, and the correction unit corrects the numerical distribution of the attribute to be checked for matching based upon a density distribution of ridges.

8. The matching apparatus according to any one of 4 through 6, wherein the biometric image is a fingerprint image, and the correction unit corrects the numerical distribution of the attribute to be checked for matching based upon a distribution of the number of ridges belonging to respective categories obtained by grouping the ridges according to an angle they form with respect to a reference direction.

9. The matching apparatus according to any one of 4 through 6, wherein the distribution obtaining unit categorizes biometric features according to the attributes the have and obtains the frequency of each category, and the matching unit matches two images against each other based upon the distribution of frequencies of the categories.

10. The matching apparatus according to 9, wherein the biometric image is a fingerprint image, and the distribution obtaining unit obtains a distribution of the number of ridges belonging to respective categories obtained by grouping the ridges according to an angle they form with respect to a reference direction.

11. The matching apparatus according to 9, wherein the biometric image is a fingerprint image, and the distribution obtaining unit obtains a distribution of the number of ridges belonging to respective categories obtained by grouping the ridges according to the length of a line parallel with a coordinate axis included in a pixel area in which the ridge appears.

What is claimed is:

1. A registration apparatus comprising:
an input unit which receives biometric information of a subject of registration;
a pre-extraction unit which extracts first feature data from biometric information by a predetermined feature extraction method;
a categorization unit which determines categorization data for use in categorizing the biometric information into a plurality of groups, by using the first feature data;
a feature extraction unit which extracts second feature data from the biometric information by using feature extraction methods adapted for the respective groups; and
a registration unit which relates the first feature data, the second feature data and the categorization data to each other and stores them as reference biometric information.

2. The registration apparatus according to claim 1, wherein the categorization unit defines the categorization data as denoting an area in which the second feature data is extracted from the input biometric information.

3. The registration apparatus according to claim 1, wherein the input biometric information is fingerprint information, and the pre-extraction unit comprises a ridge direction extraction unit for extracting from the fingerprint information a ridge direction in a fingerprint and outputs data obtained by subjecting ridge direction to a statistical process, as the first feature data.

4. The registration apparatus according to claim 2, wherein the input biometric information is fingerprint information, and the pre-extraction unit comprises a ridge direction extraction unit for extracting from fingerprint information a ridge direction in a fingerprint and outputs data obtained by subjecting the ridge direction to a statistical process, as the first feature data.

5. An authentication apparatus comprising:
an input unit which receives biometric information of a subject of registration;
a pre-extraction unit which extracts first feature data from biometric information by a predetermined feature extraction method;
a categorization unit which determines categorization data for use in categorizing the biometric information into a plurality of groups by using the first feature data;
a feature extraction unit which extracts second feature data from the biometric information by using feature extraction methods adapted for the respective groups;
a matching processing unit which stores reference biometric information to be referred to in authentication, indexing the reference biometric information using the categorization data, and which matches the second feature data against the reference biometric information by matching methods adapted for the respective groups; and
an authentication unit which authenticates the biometric information based upon a result of matching.

6. The authentication apparatus according to claim 5, wherein the categorization unit defines the categorization as denoting an area in which the second feature data is extracted from the input biometric information.

7. The authentication apparatus according to claim 5, further comprising a pre-extracted data matching unit which matches the first feature data against the first feature data included in the reference biometric information, wherein
the authentication unit refers both to a result of matching in the matching processing unit and to a result of matching in the pre-extracted data matching unit so as to determine whether to authenticate the input biometric information.

8. The authentication apparatus according to claim 6, further comprising a pre-extracted data matching unit which matches the first feature data against the first feature data included in the reference biometric information, wherein the authentication unit refers both to a result of matching in the matching processing unit and to a result of matching in the pre-extracted data matching unit so as to determine whether to authenticate the input biometric information.

9. The authentication apparatus according to claim 8, wherein the authentication unit makes a determination based upon a result obtained by weighting the result of matching in the matching processing unit and the result of matching in the pre-extracted data matching unit, the weighting being done using the categorization data.

10. The authentication apparatus according to claim 5, wherein the input biometric information is fingerprint information, and the pre-extraction unit comprises a ridge direction extraction unit for extracting from the fingerprint information a ridge direction in a fingerprint and outputs data obtained by subjecting the ridge direction to a statistical process, as the first feature data.

11. A registration method comprising:
determining categorization data for use in categorizing input biometric information into a plurality of groups, in accordance with first feature data extracted from the biometric information;
extracting second feature data from the biometric information by feature extraction methods adapted for the plurality of groups; and
relating the first feature data, the second feature data and the categorization data to each other and registering them as reference biometric information.

12. An authentication method comprising:
categorizing input biometric information into a plurality of categories in accordance with first feature data extracted from the biometric information;
extracting second feature data from the biometric information by feature extraction methods adapted for the respective groups;
matching pre-registered reference biometric information against the second feature data by matching methods adapted for the respective groups; and
authenticating the biometric information based upon a result of matching.
